(19) United States
(12) Patent Application Publication
(10) Pub. No.: US 2026/0264679 A1
(43) Pub. Date: Sep. 10, 2026

(54) VEHICLE CONTROL DEVICE AND STORAGE MEDIUM

(71) Applicant: HONDA MOTOR CO., LTD., Tokyo (JP)

(72) Inventors: Hironori HIRATA, Tokyo (JP); Takahiro OSAWA, Tokyo (JP)

(73) Assignee: HONDA MOTOR CO., LTD., Tokyo (JP)

(21) Appl. No.: 19/553,445

(22) Filed: Mar. 2, 2026

(30) Foreign Application Priority Data
Mar. 5, 2025 (JP) 2025-034256

(51) Int. Cl. B60W 30/14; B60W 30/182; B60W 50/14

(52) U.S. Cl. CPC B60W 30/146; B60W 30/182; B60W 50/14; B60W 2050/146; B60W 2420/403; B60W 2420/408; B60W 2552/05; B60W 2556/40; B60W 2556/50

(57) ABSTRACT

A vehicle control device capable of transitioning travel control between a first travel mode and a second travel mode includes at least one processor configured to perform travel control for moving a vehicle to a target position. The processor is configured to, when the vehicle enters a predetermined determination area while the vehicle is traveling in the first travel mode, determine whether a travel condition of the second travel mode is satisfied by matching processing between a position of the vehicle estimated in the first travel mode and a position of the vehicle estimated in the second travel mode, and transition to the second travel mode when the travel condition is satisfied.

### CROSS-REFERENCE TO RELATED APPLICATIONS

This application is based on and claims priority under 35 USC 119 from Japanese Patent Application No. 2025-034256 filed on Mar. 5, 2025, the entire content of which is incorporated herein by reference.

### TECHNICAL FIELD

The present disclosure relates to a vehicle control device and a non-transitory storage medium storing a vehicle control program.

### BACKGROUND ART

In recent years, efforts have been actively made to provide access to a sustainable transportation system in consideration of vulnerable people among traffic participants. In order to implement the above, focus has been placed on research and development on further improving safety and convenience of traffic by research and development related to autonomous driving techniques.

In the related art, it is known that in an autonomous driving system that causes a vehicle to travel autonomously without requiring a driving operation of a user, a route taken when a vehicle travels to a target position by the driving operation of the user is stored, and when the vehicle travels toward the same target position or on the same route, the vehicle is caused to travel based on a stored route history. Further, it is known that information on a route from a current position to the target position is generated based on information acquired by an in-vehicle sensor to cause the vehicle to travel.

For example, JP2020-56757A describes a technique in which, in order to travel across a plurality of maps, a relative position of a moving object with respect to a coordinate origin in a predetermined coordinate system and a relative position of the moving object with respect to a self-position identification origin which is a movement start position of the moving object are obtained, and a relative position relationship information representing a relative position of the coordinate origin with respect to a plurality of self-position identification origins is updated based on the relative position of the moving object with respect to the coordinate origin and the relative position of the moving object with respect to the self-position identification origin.

JP2021-525678A describes a technique in which a transition part from a private area to a public area is detected while an automobile is driven along a track in a driving mode, and additional data related to the driving of the automobile along the track in the public area is acquired, and the additional data includes current traffic data related to the driving of the automobile in the public area adjacent to the private area.

### SUMMARY OF INVENTION

When assisting to drive a vehicle to a target position, for example, there may be general travel assistance of the vehicle performed during travel on a general road, and specific region travel assistance in which travel assistance of the vehicle is performed using a user travel route during travel to the target position by a driving operation of a user. In this case, for example, when the vehicle travels from the general road to a specific region, smooth switching of a travel mode from the general travel assistance to the specific region travel assistance is desired. However, JP2020-56757A and JP2021-525678A do not disclose the switching of the travel mode from the general travel assistance to the specific region travel assistance.

Aspects of non-limiting embodiments of the present disclosure relates to providing a vehicle control device and a non-transitory storage medium storing a vehicle control program that allow smooth transition of a travel mode. This hence contributes to development of a sustainable transportation system.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a vehicle control device capable of transitioning travel control between a first travel mode and a second travel mode, the vehicle control device including at least one processor configured to perform travel control for moving a vehicle to a target position, in which the processor is configured to, when the vehicle enters a predetermined determination area while the vehicle is traveling in the first travel mode, determine whether a travel condition of the second travel mode is satisfied by matching processing between a position of the vehicle estimated in the first travel mode and a position of the vehicle estimated in the second travel mode, and transition to the second travel mode when the travel condition of the second travel mode is satisfied.

According to an aspect of the present disclosure, there is provided a non-transitory computer-readable storage medium storing a vehicle control program for a vehicle control device causing the processor to perform processing, the vehicle control device including at least one processor that performs travel control for moving a vehicle to a target position and capable of transitioning travel control between a first travel mode and a second travel mode, the processing including, when the vehicle enters a predetermined determination area while the vehicle is traveling in the first travel mode, determining whether a travel condition of the second travel mode is satisfied by matching processing between a position of the vehicle estimated in the first travel mode and a position of the vehicle estimated in the second travel mode, and transitioning to the second travel mode when the travel condition of the second travel mode is satisfied.

According to the present disclosure, it is possible to provide a vehicle control device and a non-transitory storage medium storing a vehicle control program that allow smooth transition of the travel mode.

### BRIEF DESCRIPTION OF DRAWINGS

Exemplary embodiment(s) of the present invention will be described in detail based on the following figures, wherein:

FIG. 1 is a block diagram showing a configuration of a vehicle 1 equipped with a control device 100 of an embodiment;

FIG. 2 is a sequence diagram (part 1) showing a first operation example of the vehicle 1;

FIG. 3 is a sequence diagram (part 2) showing the first operation example of the vehicle 1;

FIG. 4 is a diagram showing an initial example of a state in which the vehicle 1 on which a user gets is traveling with a parking lot 170 at home as a target position;

FIG. 5 is a sequence diagram (part 1) showing a second operation example of the vehicle 1;

FIG. 6 is a sequence diagram (part 2) showing the second operation example of the vehicle 1;

FIG. 7 is a diagram showing a next example of the state in which the vehicle 1 on which the user gets is traveling with the parking lot 170 at home as the target position;

FIG. 8 is a sequence diagram (part 1) showing a third operation example of the vehicle 1;

FIG. 9 is a sequence diagram (part 2) showing the third operation example of the vehicle 1;

FIG. 10 is a diagram showing an initial example of a state in which the vehicle 1 on which the user gets travels with the parking lot 170 at home as an operation start position;

FIG. 11 is a sequence diagram (part 1) showing a fourth operation example of the vehicle 1;

FIG. 12 is a sequence diagram (part 2) showing the fourth operation example of the vehicle 1;

FIG. 13 is a diagram showing a next example of the state in which the vehicle 1 on which the user gets travels with the parking lot 170 at home as the operation start position;

FIG. 14 is a diagram showing a state in which the user gets on the vehicle 1 and starts an engine at a destination;

FIG. 15 is a diagram showing a state in which the vehicle 1 is traveling on a general road 210 under general road assistance;

FIG. 16 is a diagram showing a start of a private land section memorizing of the vehicle 1;

FIG. 17 is a diagram showing a state in which the vehicle 1 reaches home 200 which is the target position;

FIG. 18 is a diagram showing a state of the vehicle 1 returning to the home 200 along a travel route D different from a travel route C in FIG. 17;

FIG. 19 is a diagram showing a state of the vehicle 1 returning to the home 200 along the same travel route as the travel route C in FIG. 17;

FIG. 20 is a diagram showing an example of switching of a travel mode at a travel direction switching position;

FIG. 21 is a diagram showing another example of switching of the travel mode at the travel direction switching position;

FIG. 22 is a diagram showing an example of switching of the travel mode at a temporary stop position;

FIG. 23 is a diagram showing an example of switching of the travel mode at the temporary stop position.

### DESCRIPTION OF EMBODIMENTS

Hereinafter, an embodiment of a vehicle control device and a non-transitory storage medium storing a vehicle control program of the present disclosure will be described with reference to the accompanying drawings.

Vehicle 1 Equipped with Control Device 100 of Embodiment

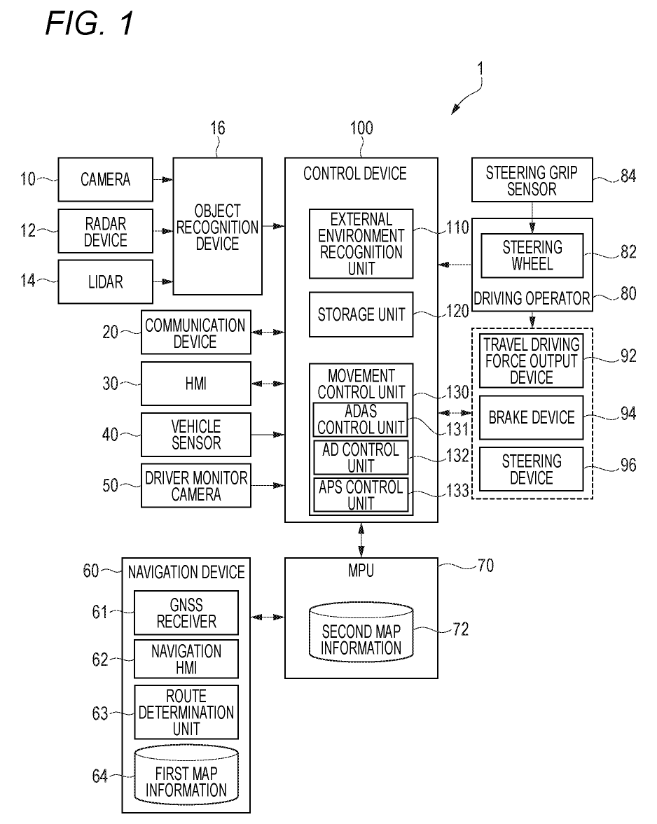

FIG. 1 is a block diagram showing a configuration of a vehicle 1 equipped with a control device 100 of an embodiment. The control device 100 is an example of a "vehicle control device" in the present embodiment. The vehicle 1 is a vehicle that can perform so-called autonomous driving or assisted driving. The vehicle 1 is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by an electric generator connected to the internal combustion engine or electric power discharged from a secondary battery or a fuel cell.

The vehicle 1 includes a camera 10, a radar device 12, a LIDAR (light detection and ranging) 14, an object recognition device 16, a communication device 20, a HMI (human machine interface) 30, a vehicle sensor 40, a driver monitor camera 50, a navigation device 60, a MPU (map positioning unit) 70, a driving operator 80, the control device 100, a travel driving force output device 92, a brake device 94, and a steering device 96. These devices and equipment are connected to each other via, for example, a multiplex communication line such as a controller area network (CAN) communication line, a serial communication line, or a wireless communication network.

The camera 10 is, for example, a digital camera using a solid-state imaging device such as a charge coupled device (CCD) or a complementary metal oxide semiconductor (CMOS). The camera 10 is attached to any position on the vehicle 1.

The radar device 12 emits radio waves such as millimeter waves to a periphery of the vehicle 1, and detects radio waves (reflected waves) reflected by an object to detect at least a position (distance and orientation) of the object. The radar device 12 is attached to any position on the vehicle 1.

The LIDAR 14 emits light (or an electromagnetic wave having a wavelength close to that of light) in the periphery of the vehicle 1 and measures scattered light. The LIDAR 14 detects a distance to a target based on a time elapsed from light emission to light reception. The emitted light is, for example, pulsed laser light. The LIDAR 14 is attached to any position on the vehicle 1.

The object recognition device 16 performs sensor fusion processing on a part or all of detection results of the camera 10, the radar device 12, and the LIDAR 14 to recognize a position, a type, a speed, and the like of an object. The object recognition device 16 outputs a recognition result to the control device 100. The object recognition device 16 may output the detection results of the camera 10, the radar device 12, and the LIDAR 14 to the control device 100 as they are.

The communication device 20 uses, for example, a cellular network, a Wi-Fi (registered trademark) network, Bluetooth (registered trademark), or dedicated short range communication (DSRC) to communicate with other vehicles present in the periphery of the vehicle 1 or communicate with various server devices via a radio base station.

The HMI 30 presents various types of information to an occupant of the vehicle 1 and receives an input operation from the occupant. The HMI 30 includes various types of display devices, a speaker, a buzzer, a touch panel, a switch, a key, and the like.

The vehicle sensor 40 includes a vehicle speed sensor that detects a speed of the vehicle 1, an acceleration sensor that detects an acceleration, a yaw rate sensor that detects an angular velocity around a vertical axis, an azimuth sensor that detects an orientation of the vehicle 1, and the like.

The driver monitor camera 50 is, for example, a digital camera using a solid-state imaging device such as the CCD or the CMOS. The driver monitor camera 50 is attached to any position on the vehicle 1 in a position and an orientation in which a head of an occupant (hereinafter, also referred to as a "driver") seated in a driver's seat of the vehicle 1 can be imaged from the front (that is, in an orientation in which a face is imaged).

The navigation device 60 includes, for example, a GNSS (global navigation satellite system) receiver 61, a navigation HMI 62, and a route determination unit 63. The navigation device 60 stores first map information 64 in a storage device such as a hard disk drive (HDD) or a flash memory.

The GNSS receiver 61 specifies a position of the vehicle 1 based on a signal received from a GNSS satellite. The position of the vehicle 1 may be specified or complemented by an inertial navigation system (INS) using an output of the vehicle sensor 40.

The navigation HMI 62 includes a display device, a speaker, a touch panel, a key, and the like. The navigation HMI 62 may be made common to the HMI 30 partially or entirely.

For example, with reference to the first map information 64, the route determination unit 63 determines a route (hereinafter, also referred to as an "on-map route") from the position of the vehicle 1 specified by the GNSS receiver 61 (or any position that is received) to a destination input by the occupant using the navigation HMI 62. The first map information 64 is, for example, information in which a road shape is expressed by a link indicating a road and nodes connected by the link. The first map information 64 may include a curvature of a road, point of interest (POI) information, and the like. The on-map route is output to the MPU 70.

The navigation device 60 may perform route guidance using the navigation HMI 62 based on the on-map route. The navigation device 60 may transmit a current position and the destination to a navigation server via the communication device 20 and acquire a route equivalent to the on-map route from the navigation server.

The MPU 70 stores, for example, second map information 72 in a storage device such as an HDD or a flash memory. The second map information 72 is map information with higher accuracy than the first map information 64. The second map information 72 includes, for example, information on a center of a lane or information on a boundary of the lane. The second map information 72 may include road information, traffic regulation information, address information, facility information, telephone number information, and the like. The second map information 72 may be updated, as required, by the communication device 20 communicating with another device.

The driving operator 80 includes, for example, an accelerator pedal, a brake pedal, a shift lever, and other operators in addition to a steering wheel 82 (an example of the steering device). A sensor that detects an operation amount or presence or absence of an operation is attached to the driving operator 80, and a detection result thereof is output to a part or all of the control device 100, the travel driving force output device 92, the brake device 94, and the steering device 96. The steering wheel 82 is not necessarily in an annular shape, and may be in a form of irregular steering, joy stick, a button, or the like.

A steering grip sensor 84 is attached to the steering wheel 82. The steering grip sensor 84 is implemented by a capacitance sensor or the like, and outputs, to the control device 100, a signal capable of detecting whether the driver is gripping the steering wheel 82.

The control device 100 includes an external environment recognition unit 110, a storage unit 120, and a movement control unit 130.

The external environment recognition unit 110 acquires, from the object recognition device 16, external environment information for recognizing an external environment of the vehicle 1 that is acquired by the camera 10, the radar device 12, and the LIDAR 14. The external environment recognition unit 110 performs external environment recognition based on the acquired external environment information (spatial information).

The storage unit 120 stores a program for the movement control unit 130 to control each unit. The storage unit 120 stores map information based on the external environment information obtained by the external environment recognition unit 110. The storage unit 120 stores map information based on the external environment information obtained by the external environment recognition unit 110 during past travel of the vehicle 1. The storage unit 120 stores a route taken during the past travel of the vehicle 1 and the map information based on the external environment information obtained by the external environment recognition unit 110 during the past travel in association with each other.

The movement control unit 130 performs travel control for moving the vehicle 1 to a target position. The movement control unit 130 includes an ADAS control unit 131, an AD control unit 132, and an APS control unit 133. The ADAS control unit 131 is implemented by an advanced driver assistance systems electronic control unit (ADAS_ECU). The AD control unit 132 is implemented by an automatic driving electronic control unit (AD_ECU). Similar to the AD control unit 132, the APS control unit 133 is implemented by an AD_ECU. However, the APS control unit 133 may be implemented by, for example, an automatic parking system electronic control unit (APS_ECU), which is a separate circuit from the AD control unit 132. The movement control unit 130 (the ADAS control unit 131, the AD control unit 132, and the APS control unit 133) is an example of a "processor" in the present embodiment.

Each of the ADAS_ECU, the AD_ECU, and the APS_ECU is implemented by, for example, a hardware processor such as a central processing unit (CPU) executing a program (software). A part or all of these components may be implemented by hardware (including circuitry) such as a large scale integration (LSI), an application specific integrated circuit (ASIC), a field-programmable gate array (FPGA), and a graphics processing unit (GPU), or may be implemented by cooperation of software and hardware. The program may be stored in advance in a storage device such as an HDD or a flash memory of the control device 100.

The movement control unit 130 can perform travel control of the vehicle 1 by general road assistance and travel control of the vehicle 1 by private land section control. The general road assistance is, for example, a travel mode of assisted driving applied to the travel of the vehicle 1 on a general road and a highway. The private land section control is a travel mode of the assisted driving applied to the travel of the vehicle 1 in a private land section, for example, in a private land (including a private road) in the United States or the like from the general road to an inside of a parking lot of the private land. The general road assistance is an example of a "first travel mode" in the present embodiment. The private land section control is an example of a "second travel mode" in the present embodiment.

The general road assistance and the private land section control are travel modes using map information of different formats. For example, in the general road assistance, map data such as an SD map (standard depression map) or an HD map (high depression map) that is created in advance by, for example, a map manufacturer is used as the map information. In the private land section control, map data such as simultaneous localization and mapping (SLAM), that is created while specifying a self-position of an automobile in an unknown environment, is used.

The private land section control may include control of automatic parking to a parking lot (such as a garage) and control of automatic exit from the parking lot.

When the vehicle 1 enters a predetermined determination area for determining a travel condition of the vehicle 1 during travel of the vehicle 1 in which the vehicle 1 is travel-controlled by the general road assistance, the movement control unit 130 determines whether a travel condition for performing the travel control on the vehicle 1 by the private land section control is satisfied. When it is determined that the travel condition is satisfied, the movement control unit 130 transitions the travel control of the vehicle 1 from the general road assistance to the private land section control. The "determination area" is, for example, an area in which a distance remaining on a travel route of the vehicle 1 to the target position is equal to or less than a preset distance (for example, a remaining distance is equal to or less than 88 m).

When the vehicle 1 enters the determination area while the vehicle 1 is traveling under the general road assistance, the movement control unit 130 performs the deceleration control of the vehicle 1 to determine whether the travel condition is satisfied, and issues the first notification regarding the deceleration control to the user. Further, when the vehicle 1 enters the determination area while the vehicle 1 is traveling under the general road assistance, the movement control unit 130 may issue a second notification prompting the user to perform the deceleration control of the vehicle 1 to determine whether the travel condition is satisfied. That is, the movement control unit 130 may decelerate the vehicle 1 by, for example, a brake operation of the user instead of decelerating the vehicle 1 by control of the control unit.

The travel condition in the private land section control is, for example, that the travel route of the vehicle 1 to the target position includes a region in which travel under the private land section control is possible. Whether the "region in which travel under the private land section control is possible" is included is determined by, for example, whether map information having a matching feature is stored in the storage unit 120. Alternatively, the map information stored in the storage unit 120 may be associated with an area (represented by latitude and longitude or the like), and the determination may be made based on whether the associated area is included in the "route to the target position".

Further, the travel condition in the private land section control includes a condition that a position of the vehicle 1 estimated under the general road assistance matches a position of the vehicle 1 estimated under the private land section control (a difference is equal to or less than a predetermined value).

In the private land section control, the movement control unit 130 causes the vehicle 1 to travel based on the map information stored in the storage unit 120 and the external environment information obtained by the external environment recognition unit 110. The travel condition in the private land section control at this time is, for example, that the external environment information obtained by the external environment recognition unit 110 in the determination area and the map information stored in the storage unit 120 satisfy a predetermined matching condition. The "matching condition" is, for example, that a degree of matching between the external environment information and the map information is equal to or greater than a threshold. The map information stored in the storage unit 120 includes the map information based on the external environment information obtained by the external environment recognition unit 110 during the past travel of the vehicle 1.

Here, the map information includes point cloud data representing a space in the periphery of the vehicle 1, and the matching determination is performed using the point cloud data. Further, the map information includes time-series data of the point cloud data (for example, time stamps or point cloud data for each elapsed time), and the matching determination may be performed using the time-series data.

In the private land section control, the movement control unit 130 causes the vehicle 1 to travel based on the external environment information obtained by the external environment recognition unit 110 and map information corresponding to a current travel route of the vehicle 1 among a plurality of pieces of map information stored in the storage unit 120 and associated with routes taken during the past travel. The "map information corresponding to a current travel route" is map information associated with a travel route taken during the past travel that satisfies a predetermined matching condition with the current travel route. The route taken during the past travel includes, for example, a route along which the vehicle 1 travels under the general road assistance when transitioning from the general road assistance to the private land section control. Specifically, when the vehicle 1 enters the private land from the general road, the route during the past travel includes a travel direction of the vehicle 1 traveling on the general road or the like.

The movement control unit 130 transitions to the private land section control when an approval operation for approving the transition to the private land section control is received from the user, and the vehicle 1 enters a travel-possible area in which travel under the private land section control is possible. The map information is map information on a region including the determination area for determining the travel condition of the vehicle 1 and the travel-possible area in which travel under the private land section control is possible.

Further, the travel condition in the private land section control includes at least one of a condition that a state in which a travel speed of the vehicle 1 in the determination area exceeds a first speed does not continue for a predetermined time or more, or a condition that the travel speed of the vehicle 1 in the determination area does not exceed a second speed. The first speed is, for example, 15 km/h. The predetermined time is, for example, a time for traveling 50 m at a speed of 15 km/h or more. The second speed is, for example, 30 km/h. The travel condition in the private land section control includes a condition that a state of a device in the vehicle 1 used for the private land section control is normal. The "device" includes, for example, the camera 10, the radar device 12, the LIDAR 14, and the vehicle sensor 40. When an ECU for an APS is provided, the "device" includes the APS_ECU.

The movement control unit 130 performs, for example, control to park the vehicle 1 at the target position by the private land section control. The target position includes, for example, a parking lot (a garage, a carport, or the like) on private land. The private land section control for parking the vehicle 1 to the target position is performed based on route information when the vehicle 1 was parked to the target position in the past. The movement control unit 130 performs, for example, control to cause the vehicle 1 to exit from a predetermined position by the private land section control. The predetermined position includes, for example, the parking lot (the garage, the carport, or the like) on the private land. The predetermined position is an operation start position when the vehicle 1 exits.

The travel driving force output device 92 outputs, to driving wheels, a travel driving force (torque) for the vehicle to travel. The travel driving force output device 92 includes, for example, a combination of an internal combustion engine, an electric motor, a transmission, and the like, and an electronic control unit (ECU) that controls the combination. The ECU controls the above configuration according to information received from the movement control unit 130 or information received from the driving operator 80.

The brake device 94 includes, for example, a brake caliper, a cylinder that transmits a hydraulic pressure to the brake caliper, an electric motor that generates the hydraulic pressure in the cylinder, and a braking ECU. The braking ECU controls the electric motor according to the information received from the movement control unit 130 or the information received from the driving operator 80, and outputs a braking torque corresponding to a braking operation to each wheel.

The steering device 96 includes, for example, a steering ECU and an electric motor. The electric motor changes an orientation of a steered wheel, for example, by applying a force to a rack-and-pinion mechanism. The steering ECU drives the electric motor according to the information received from the movement control unit 130 or the information received from the driving operator 80 to change the orientation of the steered wheel.

### Operation of Vehicle 1

### First Operation Example

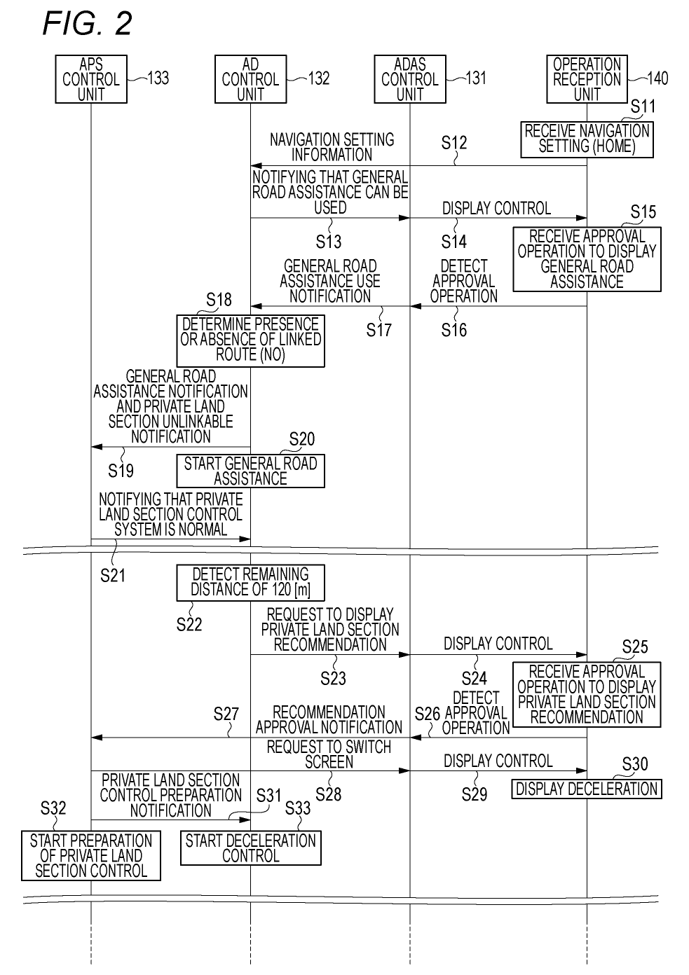

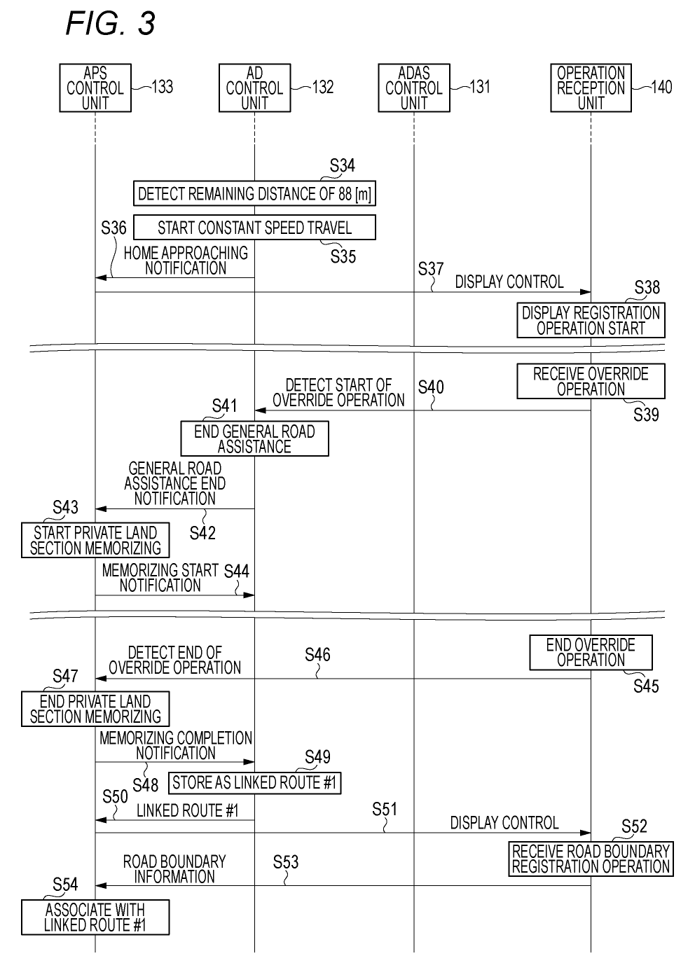

FIGS. 2 and 3 are sequence diagrams showing a first operation example of the vehicle 1. The APS control unit 133, the AD control unit 132, and the ADAS control unit 131 are control units provided in the movement control unit 130 (see FIG. 1). An operation reception unit 140 is the navigation HMI 62, the HMI 30, or the driving operator 80 (see FIG. 1). The first operation example is an operation example in a case where a user who gets on the vehicle 1 returns home from a destination and causes the vehicle 1 to enter a parking lot at home. The target position of the vehicle 1 is the parking lot at home. However, in the first operation example, it is assumed that route information when the vehicle 1 is caused to enter the parking lot at home is not yet stored in the storage unit 120, and thus the vehicle 1 cannot be caused to enter the parking lot at home by the private land section control.

First, the user operates, for example, the navigation HMI 62 of the navigation device 60 to perform navigation setting to set the target position of the vehicle 1 as the parking lot at home.

The operation reception unit 140 receives the navigation setting from the user who sets the target position as the parking lot at home (step S11). The operation reception unit 140 transmits the navigation setting information indicating the received navigation setting to the AD control unit 132 (step S12).

Based on the received navigation setting information, the AD control unit 132 recognizes that the vehicle can proceed near the home by the general road assistance and that the vehicle does not arrive at the parking lot at home by the general road assistance alone. The AD control unit 132 notifies the ADAS control unit 131 that the general road assistance can be used (step S13).

The ADAS control unit 131 performs display control on the operation reception unit 140 to display, on the navigation HMI 62, that the general road assistance can be used in the navigation to the home set by the user (step S14).

In order to notify the user, the operation reception unit 140 displays on the navigation HMI 62 that the general road assistance can be used (step S15). It is assumed that the user approves the use of the general road assistance in response to the notification. The operation reception unit 140 receives an approval operation from the user on the navigation HMI 62 (step S15). The operation reception unit 140 outputs, to the ADAS control unit 131, an operation detection signal notifying that the approval operation from the user is detected (step S16).

The ADAS control unit 131 notifies the AD control unit 132 that the user uses the general road assistance, based on the operation detection signal from the operation reception unit 140 (step S17).

In travel control of the vehicle 1 to the parking lot at home of the user, the AD control unit 132 determines whether a route linked to a travel route of the general road assistance is stored in the storage unit 120, that is, determines presence or absence of a linked route (step S18). As described above, the route information when the vehicle 1 is caused to enter the parking lot at home is not yet stored in the storage unit 120. Therefore, the determination for the presence or absence of the linked route is "NO". The AD control unit 132 notifies the APS control unit 133 that the general road assistance is used and that there is no linked route, that is, a link to the private land section control is impossible (step S19). Then, the AD control unit 132 starts the travel control of the vehicle 1 by the general road assistance (step S20).

When receiving a general road assistance notification and a private land section unlinkable notification, the APS control unit 133 notifies the AD control unit 132 that a state of a private land section control system is normal and travel control based on the private land section control can be performed (step S21).

The AD control unit 132 detects, based on a signal received by the GNSS receiver 61, that a travel point of the vehicle 1 traveling under the general road assistance is a point at a remaining distance of 120 m to the parking lot at home which is the target position (step S22). The AD control unit 132 requests the ADAS control unit 131 to display a private land section control recommendation for recommending the travel control that is based on the private land section control (step S23).

In the travel control of the vehicle 1 to the home, the ADAS control unit 131 performs display control on the operation reception unit 140 to display the recommendation of the private land section control on the navigation HMI 62 (step S24).

The operation reception unit 140 displays, on the navigation HMI 62, that the use of the private land section control is recommended (step S25). It is assumed that the user approves the use of the private land section control in response to the display. The operation reception unit 140 receives an approval operation from the user on the navigation HMI 62 (step S25). The operation reception unit 140 outputs, to the ADAS control unit 131, an operation detection signal notifying that the approval operation from the user is detected (step S26).

The ADAS control unit 131 notifies the APS control unit 133 that the user approves the private land section control recommendation, based on the operation detection signal from the operation reception unit 140 (step S27).

When receiving a recommendation approval notification, the APS control unit 133 requests the ADAS control unit 131 to switch a screen of the navigation HMI 62 in order to cause the travel of the vehicle 1 to conform to the private land section control (step S28).

The ADAS control unit 131 performs display control on the operation reception unit 140 to display, on the navigation HMI 62, a screen for causing the travel of the vehicle 1 to conform to the private land section control (step S29).

The operation reception unit 140 displays on the navigation HMI 62 that the travel speed of the vehicle 1 is to be reduced (step S30). For example, the operation reception unit 140 displays "Decelerate for the private land section memorizing" on the navigation HMI 62. A purpose of the private land section memorizing is to record a travel route when the user manually drives the vehicle 1 to enter the parking lot at home.

When receiving the recommendation approval notification, the APS control unit 133 notifies the AD control unit 132 to prepare for the private land section control (step S31). Then, the APS control unit 133 starts the preparation of the private land section control (step S32).

When receiving a private land section control preparation notification, the AD control unit 132 starts deceleration control of the vehicle 1 (step S33). The deceleration control is, for example, such control that the travel speed is 15 km/h when the travel point of the vehicle 1 is a point at a remaining distance of 88 m to the parking lot at home.

Then, in FIG. 3, the AD control unit 132 detects, based on a signal received by the GNSS receiver 61, that the travel point of the vehicle 1 is a point at a remaining distance of 88 m to the parking lot at home which is the target position (step S34). The AD control unit 132 starts constant speed travel (step S35). The AD control unit 132 starts the constant speed travel at, for example, 15 km/h to which the speed is deceleration-controlled. The AD control unit 132 transmits, to the APS control unit 133, a home approaching notification indicating that the vehicle 1 is approaching the home which is the target position (step S36).

When receiving the home approaching notification, the APS control unit 133 performs display control on the operation reception unit 140 to display, on the navigation HMI 62, a screen for moving the vehicle 1 to the parking lot at home by a driving operation of the user (step S37).

The operation reception unit 140 displays, on the navigation HMI 62, a registration operation start which is a screen display for moving the vehicle 1 to the parking lot at home by the driving operation of the user (step S38). For example, the operation reception unit 140 displays "Start the private land section memorizing. Please drive on the driveway." on the navigation HMI 62. The driveway is, for example, a travel route to a target position (the parking lot at home) to which the vehicle 1 moves on a private land. It is assumed that the user starts an override operation of driving on the driveway in response to the display. The operation reception unit 140 receives the override operation of the user (step S39). The operation reception unit 140 outputs, to the AD control unit 132, a start detection signal for notifying that the start of the override operation of the user is detected (step S40).

The AD control unit 132 ends the travel control of the vehicle 1 by the general road assistance, based on the start detection signal from the operation reception unit 140 (step S41). The AD control unit 132 notifies the APS control unit 133 that the control based on the general road assistance is ended (step S42).

The APS control unit 133 starts the private land section memorizing for storing, in the storage unit 120, route information on the override operation started by the user (step S43). The APS control unit 133 notifies the AD control unit 132 that the private land section memorizing is started (step S44). The APS control unit 133 may control the operation reception unit 140 to display that a private land section in the override operation is being registered. Further, the APS control unit 133 may control the navigation HMI 62 to display, for example, the override operation of the user during execution of the private land section memorizing.

The operation reception unit 140 ends the reception of the override operation on the driveway by the user (step S45). The operation reception unit 140 detects that the override operation is ended, for example, when the vehicle 1 enters the parking lot at home and is stopped. The operation reception unit 140 outputs, to the APS control unit 133, an end detection signal notifying that the end of the override operation is detected (step S46).

The APS control unit 133 ends the private land section memorizing for storing the route information on the override operation on the driveway, based on the end detection signal from the operation reception unit 140 (step S47). At this time point, depending on a data processing timing, storage in a non-volatile memory may not be ended. The APS control unit 133 notifies the AD control unit 132 that the private land section memorizing is completed (step S48).

When receiving a memorizing completion notification, the AD control unit 132 stores the route linked to the travel route of the general road assistance in the storage unit 120 as a linked route #1 (step S49). For example, when the vehicle 1 approaches home on the route on which the vehicle 1 travels this time and enters the private road on the private land from the general road, the AD control unit 132 stores, as the linked route #1, route information such as a direction from which the vehicle 1 enters the private road while traveling on the general road, and whether the vehicle 1 enters the private road by turning left or turning right. The AD control unit 132 transmits the stored information on the linked route #1 to the APS control unit 133 (step S50).

The APS control unit 133 performs display control on the operation reception unit 140 to display, on the navigation HMI 62, a screen representing map information including the travel route on which the user performs the override operation (step S51). The user sets a road boundary on the map information displayed on the navigation HMI 62. The road boundary indicates a boundary of a region in which the vehicle 1 can travel under the private land section control, that is, a boundary of the travel-possible area.

The operation reception unit 140 receives a road boundary registration operation for registering the road boundary set by an operation of the user (step S52). The operation reception unit 140 transmits road boundary information on the set road boundary to the APS control unit 133 (step S53).

The APS control unit 133 stores the received linked route #1 and road boundary information in the storage unit 120 in association with the information on the override operation stored by the private land section memorizing (step S54).

In the process shown in FIGS. 2 and 3, for example, steps S23 to S27 may be omitted, and the approval operation from the user regarding the use of the private land section control may not be received. In this case, the AD control unit 132 notifies the APS control unit 133 to proceed from step S22 to step S28.

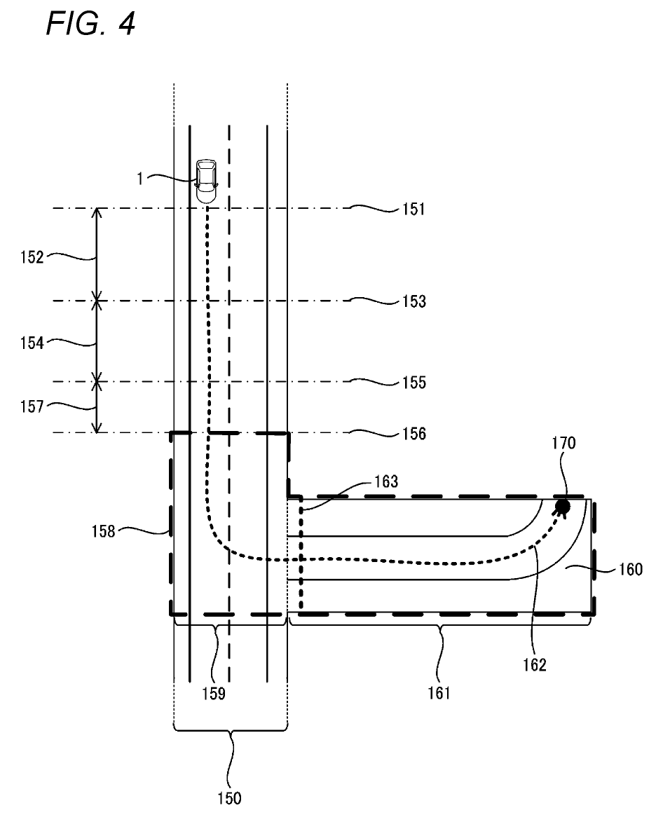

FIG. 4 is a diagram showing an initial example of a state in which the vehicle 1 on which the user gets is traveling with the parking lot 170 at home as the target position. The initial example is an example in a situation in which the route information when the vehicle 1 is caused to enter the parking lot 170 at home is not yet stored, as described in the first operation example of FIGS. 2 and 3. In FIG. 4, the vehicle 1 is traveling on a general road 150 while receiving the travel control that is based on the general road assistance. A current travel position of the vehicle 1 is a point 151 at which the remaining distance to the parking lot 170 at home is 120 m.

When reaching the point 151 at a remaining distance of 120 m, the vehicle 1 starts recommending the user to apply the private land section control to the travel control until the vehicle 1 enters the parking lot 170 at home. When an approval of the recommendation from the user is received, the vehicle 1 starts deceleration. A section in which the recommendation is made to the user is a recommendation section 152, and a position where the approval of the recommendation is received from the user is an approval point 153.

The vehicle 1 decelerates such that the speed is 15 km/h at a point where the remaining distance to the parking lot 170 at home is 88 m. A section in which the deceleration control is performed to set the speed to 15 km/h is a deceleration section 154, and a position at a remaining distance of 88 m where the deceleration is completed is a deceleration completion point 155.

When reaching the deceleration completion point 155 at a remaining distance of 88 m, the vehicle 1 performs constant speed travel at 15 km/h. Then, the vehicle 1 prompts the user to perform the override operation in which the user manually drives to travel along the travel route to the parking lot 170 at home. In response to this, the user starts the override operation by manual driving. A position where the user starts the override operation is an override start point 156, and a section of the constant speed travel until the override operation is started is a constant speed section 157.

When the override operation of the user is started, the private land section memorizing for storing the route information on the override operation into the storage unit 120 is started. A section in which the private land section memorizing is performed is a section from a point where the override operation is started to a point where the vehicle 1 enters the parking lot 170 at home, and is a private land section memorizing section 158 in a range surrounded by a thick broken line in FIG. 4. The private land section memorizing section 158 includes a general road region 159, which is a region of the general road 150, and a driveway (private road) 161 on a private land 160. The user causes the vehicle 1 to travel on a travel route in the private land section memorizing section 158 by manual driving of the user.

In this way, the vehicle 1 turns left from the general road 150 and travels to the driveway 161 on the private land 160 in a section from the point 151 at a remaining distance of 120 m to the parking lot 170 at home, as indicated by a movement route 162 indicated by a broken line. Then, information on the movement route 162 in the private land section memorizing section 158 is stored in the storage unit 120 together with the linked route #1 linked to the travel route of the general road assistance. At this time, in the private land section memorizing section 158, a road boundary 163 indicating a boundary of a region in which the vehicle 1 can travel under the private land section control is displayed. A position of the road boundary 163 is configured to be set to any position by an operation of the user. The set road boundary 163 is stored in association with the movement route 162 and the linked route #1.

### Second Operation Example

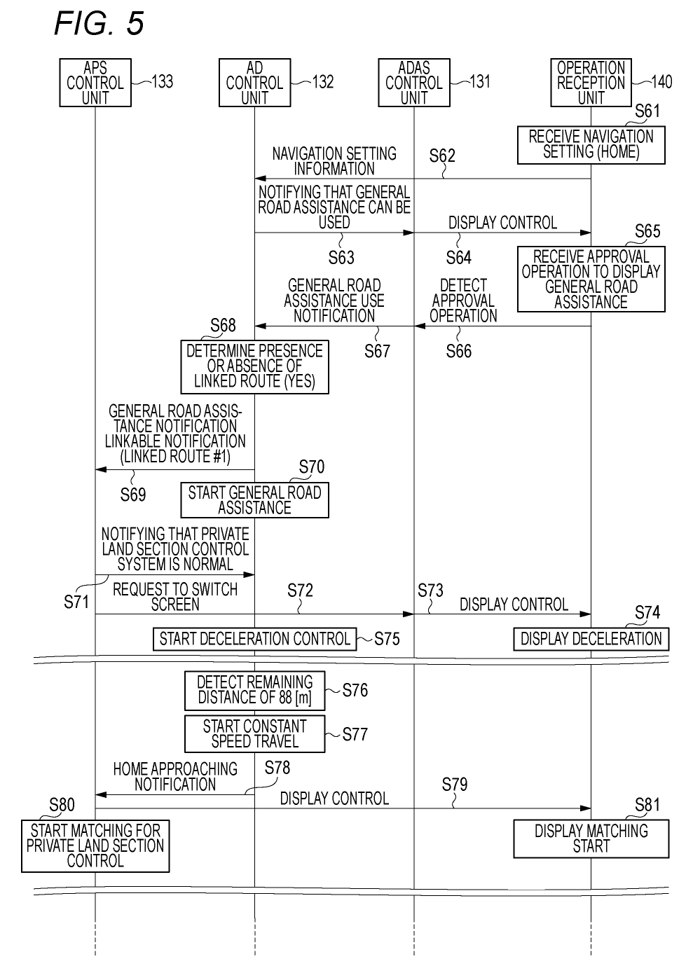

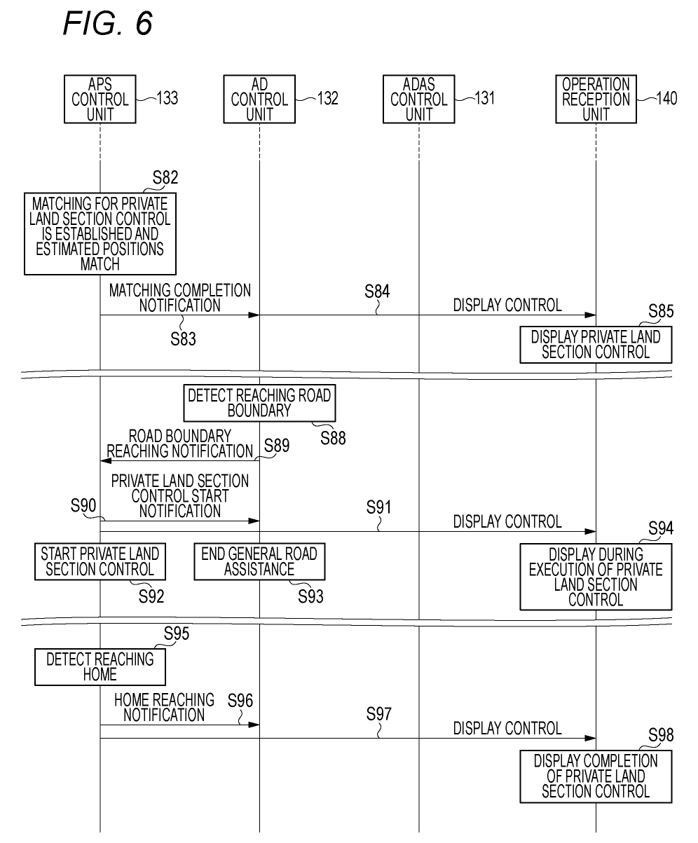

FIGS. 5 and 6 are sequence diagrams showing a second operation example of the vehicle 1. The second operation example is the same as the first operation example as being an operation example in which the user who gets on the vehicle 1 returns home from the destination and causes the vehicle 1 to enter the parking lot at home, but is different from the first operation example in that the route information when the vehicle 1 is caused to enter the parking lot at home is stored in the storage unit 120 and the vehicle 1 can enter the parking lot at home under the private land section control.

In FIG. 5, processing from step S61 to step S67 is similar to processing from step S11 to step S17 in the first operation example in FIG. 2.

Next, in the travel control of the vehicle 1 to the parking lot at home of the user, the AD control unit 132 determines whether the route linked to the travel route of the general road assistance is stored in the storage unit 120, that is, determines the presence or absence of the linked route (step S68). As described above, the linked route #1 when the vehicle 1 enters the parking lot at home is stored in the storage unit 120 in association with the information at the time of the override operation stored by the private land section memorizing and the road boundary information. Therefore, the determination for the presence or absence of the linked route is "YES". The AD control unit 132 notifies the APS control unit 133 that the general road assistance is used and that there is a linked route, that is, the link to the private land section control is likely to be possible (step S69). The stored linked route is, for example, the "linked route #1" stored in step S49 of the first operation example. The AD control unit 132 starts the travel control of the vehicle 1 by the general road assistance (step S70).

When receiving the general road assistance notification and a private land section linkable notification, the APS control unit 133 notifies the AD control unit 132 that the state of the private land section control system is normal and the travel control based on the private land section control can be performed (step S71). When receiving the general road assistance notification and the private land section linkable notification, the APS control unit 133 requests the ADAS control unit 131 to switch a screen of the navigation HMI 62 in order to cause the travel of the vehicle 1 to conform to the private land section control (step S72).

The ADAS control unit 131 performs the display control on the operation reception unit 140 to display, on the navigation HMI 62, a screen for causing the travel of the vehicle 1 to conform to the private land section control (step S73).

The operation reception unit 140 displays on the navigation HMI 62 that a travel speed of the vehicle 1 is to be reduced (step S74). The display on the navigation HMI 62 to decelerate the travel speed is an example of the "first notification" of the present embodiment. For example, the operation reception unit 140 displays "Decelerate for matching" on the navigation HMI 62. A purpose of the matching is to confirm a degree of matching between current external environment information obtained by the external environment recognition unit 110 and the map information associated with the linked route #1 stored in the storage unit 120.

When the deceleration is displayed by the operation reception unit 140, the AD control unit 132 starts the deceleration control of the vehicle 1 (step S75). This deceleration control is performed such that the travel speed is 15 km/h when the travel point of the vehicle 1 is a point at a remaining distance of 88 m to the parking lot at home, for example. The AD control unit 132 detects, based on a signal received by the GNSS receiver 61, that the travel point of the vehicle 1 is a point at a remaining distance of 88 m to the parking lot at home (step S76). The AD control unit 132 starts the constant speed travel at, for example, 15 km/h to which the speed is deceleration-controlled (step S77). The AD control unit 132 transmits, to the APS control unit 133, the home approaching notification indicating that the vehicle 1 is approaching the home which is the target position (step S78).

When receiving the home approaching notification, the APS control unit 133 performs the display control on the operation reception unit 140 to display, on the navigation HMI 62, a screen for notifying the user of a start of matching (step S79).

Next, the APS control unit 133 starts matching for the private land section control (step S80). The matching for the private land section control is, for example, determining a degree of matching between the map information of the private land section control stored in the storage unit 120 and the external environment information obtained by the external environment recognition unit 110.

The operation reception unit 140 displays, on the navigation HMI 62, a matching start, which is a screen display for notifying that the matching is started (step S81). For example, the operation reception unit 140 displays "The matching for the private land section control is started." on the navigation HMI 62. A purpose of the private land section control is to perform control to cause the vehicle 1 to enter the parking lot 170 at home.

When the matching for the private land section control started in step S80 is established, the APS control unit 133 performs matching processing between the position of the vehicle 1 estimated under the general road assistance and the position of the vehicle 1 estimated under the private land section control. When the matching for the private land section control is established and the estimated positions match (step S82), the APS control unit 133 proceeds to step S83.

The estimated positions matching each other means, for example, that a difference between the position of the vehicle 1 estimated under the general road assistance and the position of the vehicle 1 estimated under the private land section control is equal to (matches) or less than a threshold. After the matching for the private land section control is established, the matching processing between the position of the vehicle 1 estimated under the general road assistance and the position of the vehicle 1 estimated under the private land section control may be repeatedly performed. In this case, the movement control unit 130 may wait until the estimated positions match.

Further, in the case where the matching processing is repeatedly performed, the estimated positions matching each other may mean that matching processing in which the difference between the position of the vehicle 1 estimated under the general road assistance and the position of the vehicle 1 estimated under the private land section control is equal to or less than the threshold has continued a predetermined number of times or more. Further, the estimated positions matching each other may mean that the difference between the position of the vehicle 1 estimated under the general road assistance and the position of the vehicle 1 estimated under the private land section control is equal to or less than the threshold in n or more determinations among the N times of matching processing (N > n).

In step S83, the movement control unit 130 notifies the AD control unit 132 that the matching for the private land section control is completed (step S83).

The AD control unit 132 performs display control on the operation reception unit 140 to display on the navigation HMI 62 that the matching is completed and the private land section control is possible in the travel to the parking lot at home because the matching is completed (step S84). At this time, the AD control unit 132 proceeds to next processing without receiving, from the user, an approval operation for transitioning the travel control of the vehicle 1 from the general road assistance to the private land section control.

In order to notify the user, the operation reception unit 140 displays on the navigation HMI 62 that the matching is completed and the private land section control is possible (step S85).

Next, the AD control unit 132 detects that the vehicle reaches the road boundary by the travel control that is based on the general road assistance (step S88). The road boundary is at, for example, a position of the road boundary set by the user in the first operation example described above. The AD control unit 132 notifies the APS control unit 133 that the vehicle 1 reaches the road boundary (step S89).

The APS control unit 133 issues, to the AD control unit 132, a private land section control start notification indicating that the travel control of the vehicle 1 based on the private land section control is to be started (step S90). Further, the APS control unit 133 performs display control on the operation reception unit 140 to display on the navigation HMI 62 that the vehicle 1 is to travel under the private land section control (step S91). Then, the APS control unit 133 starts the private land section control of the vehicle 1 (step S92).

Since the estimated positions match each other in step S82 described above, the transition to the private land section control is performed without receiving the approval operation from the user, but when the estimated positions do not match each other in step S82, the movement control unit 130 may not transition to the private land section control or may transition to the private land section control after receiving the approval operation from the user.

When receiving the private land section control start notification, the AD control unit 132 ends the travel control of the vehicle 1 that is based on the general road assistance (step S93). The operation reception unit 140 displays, on the navigation HMI 62, a screen during execution of the private land section control for notifying that the travel control of the vehicle 1 is being performed by the private land section control (step S94).

When the vehicle 1 enters the parking lot 170 at home under the private land section control, the APS control unit 133 detects that the vehicle 1 reaches home (step S95). The APS control unit 133 notifies the AD control unit 132 of reaching the home (step S96). The APS control unit 133 performs display control on the operation reception unit 140 to display on the navigation HMI 62 that the vehicle 1 reaches the home and the travel control based on the private land section control is completed (step S97).

The operation reception unit 140 displays, on the navigation HMI 62, a private land section control completion screen for notifying that the travel control based on the private land section control is completed (step S98).

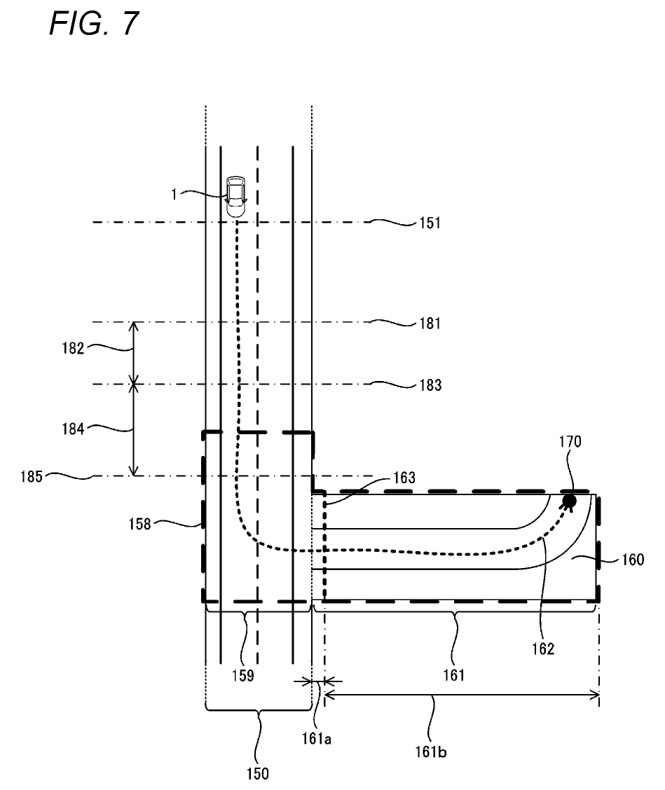

FIG. 7 is a diagram showing a next example of the state in which the vehicle 1 on which the user gets is traveling with the parking lot 170 at home as the target position. The next example is a travel example in a situation in which the route information when the vehicle 1 enters the parking lot 170 at home is stored, as described in the second operation example of FIGS. 5 and 6. In FIG. 7, the vehicle 1 is traveling on the general road 150 along the same route as in the initial example (see FIG. 4) while receiving the travel control that is based on the general road assistance. The current travel position of the vehicle 1 is the point 151 at which the remaining distance to the parking lot 170 at home is 120 m. The point 151 is the same position as the point 151 at a remaining distance of 120 m shown in the initial example.

When passing through the point 151 and traveling to a predetermined position, the vehicle 1 starts to decelerate such that the speed is 15 km/h at a point where the remaining distance to the parking lot 170 at home is 88 m. A position where the deceleration starts is a deceleration start point 181.

When starting to decelerate, the vehicle 1 notifies the user to confirm a travel condition as to whether the vehicle 1 can travel under the private land section control. A section in which the deceleration control is performed is a deceleration section 182, and a position at a remaining distance of 88 m where the deceleration is completed is a deceleration completion point 183.

When reaching the deceleration completion point 183, the vehicle 1 starts the matching for the private land section control in order to determine the travel condition for performing the private land section control. A section in which these processes are performed is a matching section 184. A position where the matching is established by performing the matching determination is a matching establishment point 185. When the matching determination is started and the vehicle 1 enters the private land section memorizing section 158 in which the route information serving as a matching target is present, the determination as to whether the matching is established is completed. A section in which the travel condition in the private land section control is determined is a determination area. The vehicle 1 performs the constant speed travel at 15 km/h during the matching.

When the matching is established, the private land section control based on the route information stored in the storage unit 120 is applied to the vehicle 1 on the condition that the position of the vehicle 1 estimated under the general road assistance matches the position of the vehicle 1 estimated under the private land section control. In FIG. 7, as the movement route 162 in the private land section memorizing section 158 surrounded by a thick broken line, the movement route 162 in the private land section memorizing section 158 stored in the storage unit 120 in the initial example (see FIG. 4) is applied. The private land section memorizing section 158 includes the general road region 159 of the general road 150 and the driveway (private road) 161 on the private land 160. In the private land section memorizing section 158, the road boundary 163 indicating a boundary of a region in which the vehicle 1 can travel under the private land section control is set. The transition to the travel that is based on the private land section control occurs when the vehicle 1 travels to a position of the road boundary 163.

In the private land section memorizing section 158, the vehicle 1 performs the travel control based on the general road assistance in the general road region 159 in the general road 150 and an excluded private road region 161a on a general road region 159 side relative to the road boundary 163 in the driveway 161. Then, the vehicle 1 performs the travel control based on the private land section control in a set private road region 161b on a parking lot 170 side relative to the road boundary 163 in the driveway 161. The vehicle 1 switches from the travel control based on the general road assistance to the travel control based on the private land section control with the road boundary 163 as a boundary. Even when it is determined that the matching is established and the travel condition is satisfied, the vehicle 1 travels under the general road assistance until the vehicle 1 enters the set private road region 161b. The set private road region 161b is the travel-possible area in which the vehicle 1 can travel under the private land section control. The travel-possible area is an area set by the user setting the road boundary 163.

In this way, the control device 100 of the present example performs the travel control of the vehicle 1 by the general road assistance, and determines, when the vehicle 1 enters the predetermined determination area, the travel condition in the private land section control by the matching processing between the position of the vehicle 1 estimated under the general road assistance and the position of the vehicle 1 estimated under the private land section control. Accordingly, it is possible to more safely and reliably switch from the general road assistance to the private land section control, and it is possible to transition to the private land section control without receiving, from the user, the approval operation for transitioning to the private land section control. Therefore, the user can transition the travel control to the private land section control without performing the approval operation for transitioning to the private land section control, and does not need to perform a complicated operation. Accordingly, it is possible to smoothly transition the control between the travel control based on the general road assistance and the travel control based on the private land section control in the vehicle 1.

When the remaining distance to the target position is equal to or less than a predetermined distance (for example, 88 m) while the vehicle 1 is traveling under the general road assistance, the control device 100 decelerates the vehicle 1 and notifies the user of the deceleration in order to determine the travel condition for transitioning to the private land section control. Accordingly, it is possible to quickly satisfy the travel condition for transitioning to the private land section control regarding the speed of the vehicle 1. Therefore, the transition in the control between the travel control based on the general road assistance and the travel control based on the private land section control can be further smoothed.

Further, when the vehicle 1 is travel-controlled by the private land section control, the control device 100 performs the travel control based on the map information corresponding to the current linked route #1 of the vehicle 1 among the plurality of pieces of map information stored in the storage unit 120 and the current external environment information obtained by the external environment recognition unit 110. Therefore, the vehicle 1 can be travel-controlled using, for example, a direction of the route from which the vehicle 1 travels in the general road assistance as the matching condition of the route information. Accordingly, it is possible to further smooth the transition of the vehicle 1 from the general road assistance to the private land section control.

In the first operation example and the second operation example, a case in which the first travel mode is the general road assistance and the second travel mode is the private land section control has been described, but the first travel mode and the second travel mode may be switched. That is, the control device 100 may perform the travel control of the vehicle 1 by the private land section control, and determine, when the vehicle 1 enters a predetermined determination area, the travel condition in the general road assistance by the matching processing between the position of the vehicle 1 estimated under the general road assistance and the position of the vehicle 1 estimated under the private land section control. In the following third operation example and fourth operation example, a case in which the first travel mode is the private land section control and the second travel mode is the general road assistance will be described. The "determination area" in this case may be an area in which a distance to the general road is within a predetermined distance, or may be the entire private road.

### Third Operation Example

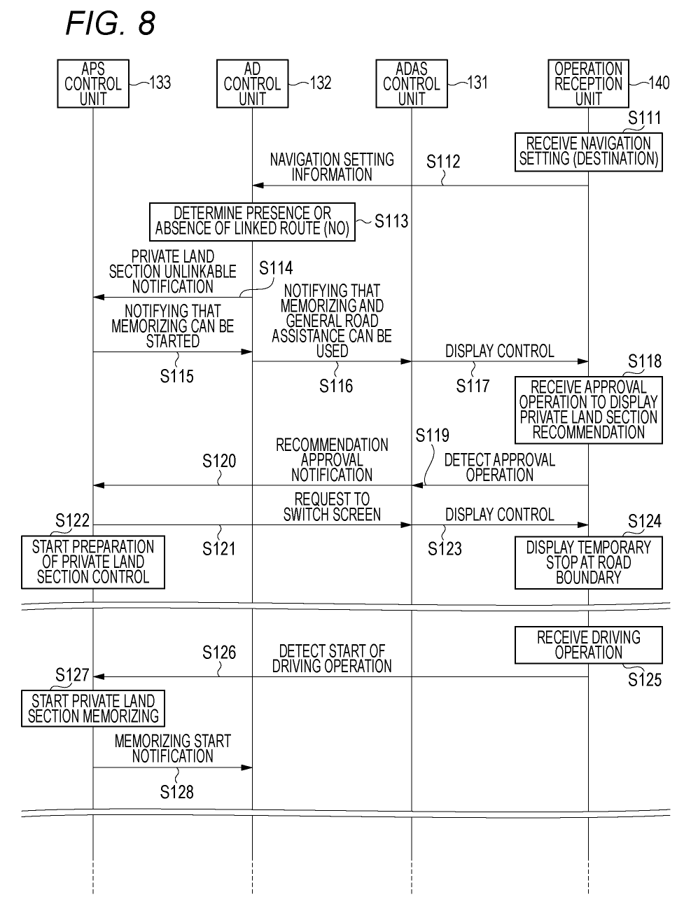

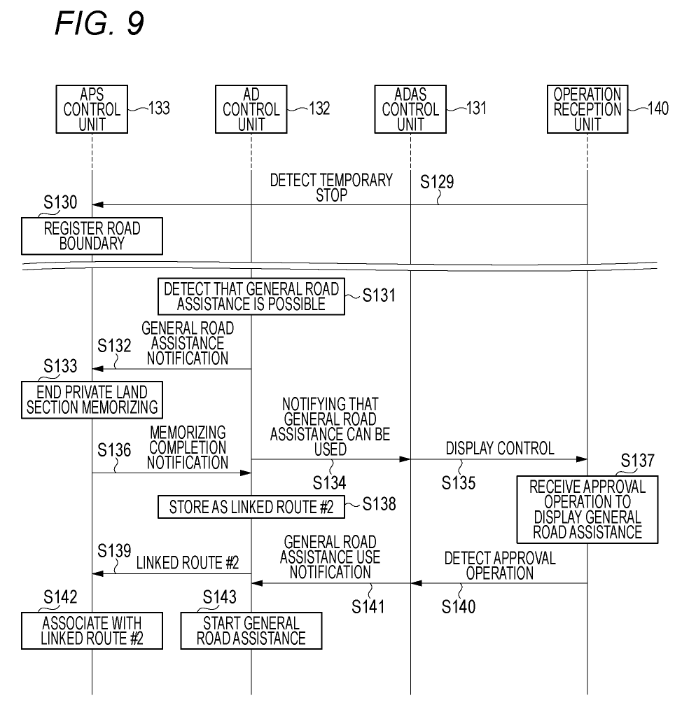

FIGS. 8 and 9 are sequence diagrams showing a third operation example of the vehicle 1. The third operation example is an operation example in a case where the user who gets on the vehicle 1 causes the vehicle 1 to exit a parking lot at home and goes out. The operation start position of the vehicle 1 is the parking lot at home. However, in the third operation example, it is assumed that the route information when the vehicle 1 is caused to exit the parking lot at home is not yet stored in the storage unit 120, and thus the vehicle 1 cannot be caused to exit the parking lot at home by the private land section control.

First, the user operates, for example, the navigation HMI 62 of the navigation device 60 to perform the navigation setting of the destination which is the target position of the vehicle 1.

The operation reception unit 140 receives the navigation setting of the destination (step S111), and transmits the received navigation setting information to the AD control unit 132 (step S112).

In travel control of the vehicle 1 from the parking lot at home to the destination, the AD control unit 132 determines whether a route linked to a travel route of the general road assistance is stored in the storage unit 120, that is, determines presence or absence of a linked route along which the vehicle 1 travels on the private land between the parking lot at home and the general road (step S113). As described above, the route information when the vehicle 1 is caused to exit the parking lot at home is not yet stored in the storage unit 120. Therefore, the determination for the presence or absence of the linked route is "NO". The AD control unit 132 notifies the APS control unit 133 that there is no linked route, that is, the link to the private land section control is impossible (step S114).

When receiving the private land section unlinkable notification, the APS control unit 133 notifies the AD control unit 132 that the private land section memorizing can be started (step S115).

The AD control unit 132 notifies the ADAS control unit 131 that memory processing for the private land section control and the travel control based on the general road assistance and after the memory processing can be used (step S116).

In the travel control of the vehicle 1 to the current destination, the ADAS control unit 131 performs display control on the operation reception unit 140 to display a recommendation of the memory processing for the private land section control on the navigation HMI 62 (step S117).

The operation reception unit 140 displays, on the navigation HMI 62, the recommendation of the memory processing for the private land section control (step S118). The operation reception unit 140 may further display that the travel control based on the general road assistance can be used after the memory processing for the private land section control is performed. It is assumed that the user approves to perform the memory processing for the private land section control in response to the display. The operation reception unit 140 receives an approval operation from the user on the navigation HMI 62 (step S118). The operation reception unit 140 outputs, to the ADAS control unit 131, an operation detection signal notifying that the approval operation from the user is detected (step S119).

The ADAS control unit 131 notifies the APS control unit 133 that the user approves the recommendation of the memory processing for the private land section control, based on the operation detection signal from the operation reception unit 140 (step S120).

When receiving a recommendation approval notification, the APS control unit 133 requests the ADAS control unit 131 to switch a screen of the navigation HMI 62 in order to allow the user to manually drive the vehicle 1 to exit the parking lot (step S121). Then, the APS control unit 133 starts preparation of the memory processing for the private land section control (step S122).

When receiving the request from the APS control unit 133, the ADAS control unit 131 performs display control on the operation reception unit 140 to display, on the navigation HMI 62, a screen for allowing the user to manually drive the vehicle 1 to exit the parking lot (step S123).

The operation reception unit 140 displays on the navigation HMI 62 that the vehicle 1 is to travel on the driveway after the vehicle 1 exits the parking lot, and to temporarily stop at a road boundary of the driveway (step S124). For example, the operation reception unit 140 displays "Please drive on the driveway, temporarily stop at the road boundary, and then exit onto the general road" on the navigation HMI 62. The road boundary is a position indicating a boundary portion of the driveway where travel under the private land section control is possible, and is a boundary that can be freely set by the user. Here, it is assumed that a manual driving operation of the vehicle 1 performed by the user is started. The operation reception unit 140 receives the driving operation of the user (step S125). The operation reception unit 140 outputs, to the APS control unit 133, an operation detection signal notifying that the driving operation of the user is detected (step S126).

The APS control unit 133 starts the private land section memorizing for storing, in the storage unit 120, route information on an exiting operation of the vehicle 1 in the driveway started by the user, based on the operation detection signal from the operation reception unit 140 (step S127). The APS control unit 133 notifies the AD control unit 132 that the private land section memorizing is started (step S128). The APS control unit 133 may control the operation reception unit 140 to display that private land section control in the exiting operation is being registered. The APS control unit 133 may control the navigation HMI 62 to display, for example, the exiting operation of the user during execution of the private land section memorizing.

Next, in FIG. 9, it is assumed that the vehicle 1 driven by the user exits the parking lot, travels on the private road on the private land, and is temporarily stopped at a certain position before exiting onto the general road. The operation reception unit 140 outputs, to the APS control unit 133, a stop notification signal for notifying that the vehicle 1 is temporarily stopped (step S129).

When receiving the stop notification signal from the operation reception unit 140, the APS control unit 133 registers a current position where the vehicle 1 is temporarily stopped as the position of the road boundary (step S130). After temporarily stopping the vehicle 1, the user drives the vehicle 1 from the private road, on which the vehicle 1 has been traveling, to the general road by the driving operation of the user.

The AD control unit 132 detects that the travel control of the vehicle 1 based on the general road assistance is possible, based on the fact that vehicle 1 starts to travel to the general road (step S131). The AD control unit 132 notifies the APS control unit 133 that the travel control based on the general road assistance is possible (step S132).

When receiving a general road assistance notification from the AD control unit 132, the APS control unit 133 ends the private land section memorizing for storing the route information on the exiting operation (step S133).

The AD control unit 132 notifies the ADAS control unit 131 that the travel control of the vehicle 1 based on the general road assistance can be used (step S134).

The ADAS control unit 131 performs display control on the operation reception unit 140 to display on the navigation HMI 62 that the general road assistance can be used in the navigation to the destination set by the user (step S135).

The APS control unit 133 notifies the AD control unit 132 that the private land section memorizing is completed (step S136).

In order to notify the user, the operation reception unit 140 displays on the navigation HMI 62 that the general road assistance can be used (step S137). It is assumed that the user approves the use of the general road assistance in response to the notification. The operation reception unit 140 receives an approval operation from the user on the navigation HMI 62 (step S137).

When receiving the memorizing completion notification, the AD control unit 132 stores the route linked to the travel route of the general road assistance in the storage unit 120 as a linked route #2 (step S138). For example, when the vehicle 1 travels from the private road on the private land to the general road on the route on which the vehicle 1 travels this time, the AD control unit 132 stores, as the linked route #2, route information such as a direction from which the vehicle 1 travels to the general road, for example, whether the vehicle 1 travels to the general road by turning left or turning right. The AD control unit 132 transmits the stored information on the linked route #2 to the APS control unit 133 (step S139).

The operation reception unit 140 outputs, to the ADAS control unit 131, an operation detection signal notifying that the approval operation of the use of the general road assistance from the user is detected (step S140).

The ADAS control unit 131 notifies the AD control unit 132 that the user uses the general road assistance, based on the operation detection signal from the operation reception unit 140 (step S141).

When receiving the linked route #2 from the AD control unit 132, the APS control unit 133 stores, in the storage unit 120, the route information on the exiting operation stored by the private land section memorizing and the road boundary registered in step S130 in association with the linked route #2 (step S142).

When receiving a general road assistance use notification, the AD control unit 132 starts the travel control of the vehicle 1 that is based on the general road assistance (step S143).

In the processes shown in FIGS. 8 and 9, for example, steps S116 to S120 may be omitted, and the approval operation from the user regarding the use of the private land section control may not be received. In this case, the AD control unit 132 notifies the APS control unit 133 to proceed from step S121 to step S115.

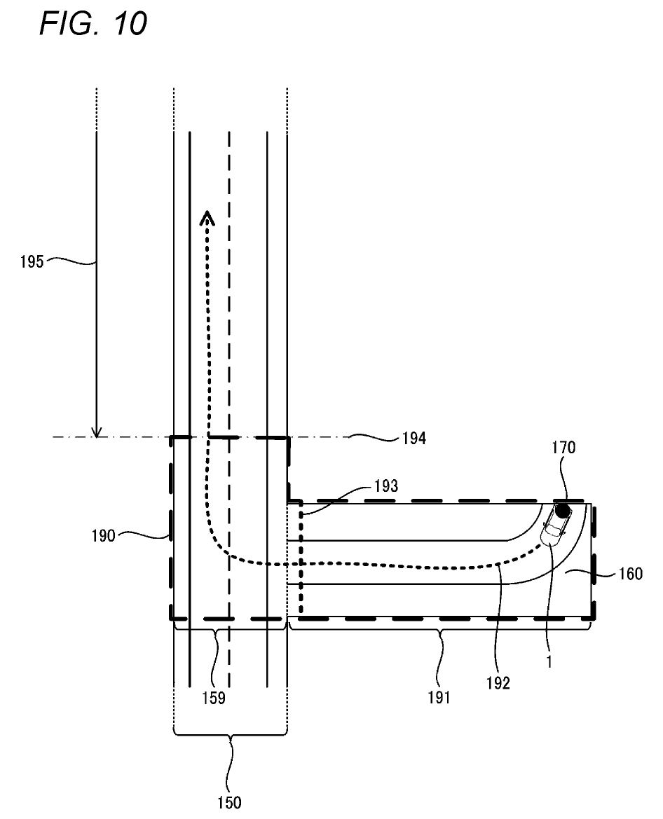

FIG. 10 is a diagram showing an initial example of a state in which the vehicle 1 on which the user gets travels with the parking lot 170 at home as the operation start position. The initial example is an example in a situation in which the route information when the vehicle 1 is caused to exit the parking lot 170 at home is not yet stored, as described in the third operation example of FIGS. 8 and 9. FIG. 10 shows a situation in which a destination is set in the navigation device 60 to allow the vehicle 1 to head toward the destination.

In the travel control from the parking lot 170 at home to the destination, the vehicle 1 determines whether a linked route for traveling on the private land 160 between the parking lot 170 and the general road 150 is stored in the storage unit 120. In this example, the linked route is not stored in the storage unit 120. Therefore, the vehicle 1 recommends to the user the memory processing for the private land section control in the travel control of the vehicle 1 to the current destination. It is assumed that the user approves the recommendation of the private land section control in response.

When the driving operation of the vehicle 1 performed by the user is started, the private land section memorizing for storing the route information on the exiting operation in the storage unit 120 is started. A section in which the private land section memorizing is performed is a section from a point where the exiting operation from the parking lot 170 is started to a point where the vehicle 1 travels from a driveway (private road) 191 on the private land 160 to the general road 150 after traveling on the driveway 191, and is a private land section memorizing section 190 in a range surrounded by a thick broken line in FIG. 10. The private land section memorizing section 190 includes the driveway 191 on the private land 160 and the general road region 159, which is a region of the general road 150. The user causes the vehicle 1 to travel on a travel route in the private land section memorizing section 190 by manual driving of the user.

When the vehicle 1 leaves the private land section memorizing section 190 and exits onto the general road 150, the travel control is performed by the general road assistance. A position where the general road assistance is started is a general road assistance start point 194, and a section in which the general road assistance is performed is a general road assistance section 195.

In this way, the vehicle 1 exits the parking lot 170 at home, travels on the driveway 191, and exits onto the general road 150 by turning right from the driveway 191, as indicated by a movement route 192 indicated by a broken line. Then, information on the movement route 192 in the private land section memorizing section 190 is stored in the storage unit 120 together with the linked route #2 linked to the travel route of the general road assistance. At this time, in the private land section memorizing section 190, a road boundary 193 indicating a boundary of a region in which the vehicle 1 can travel under the private land section control is displayed. A position of the road boundary 193 is a position where the user temporarily stops the vehicle 1 before exiting onto the general road 150 from the driveway 191, and is configured to be set to any position by an operation of the user. The set road boundary 193 is stored in association with the movement route 192 and the linked route #2.

### Fourth Operation Example

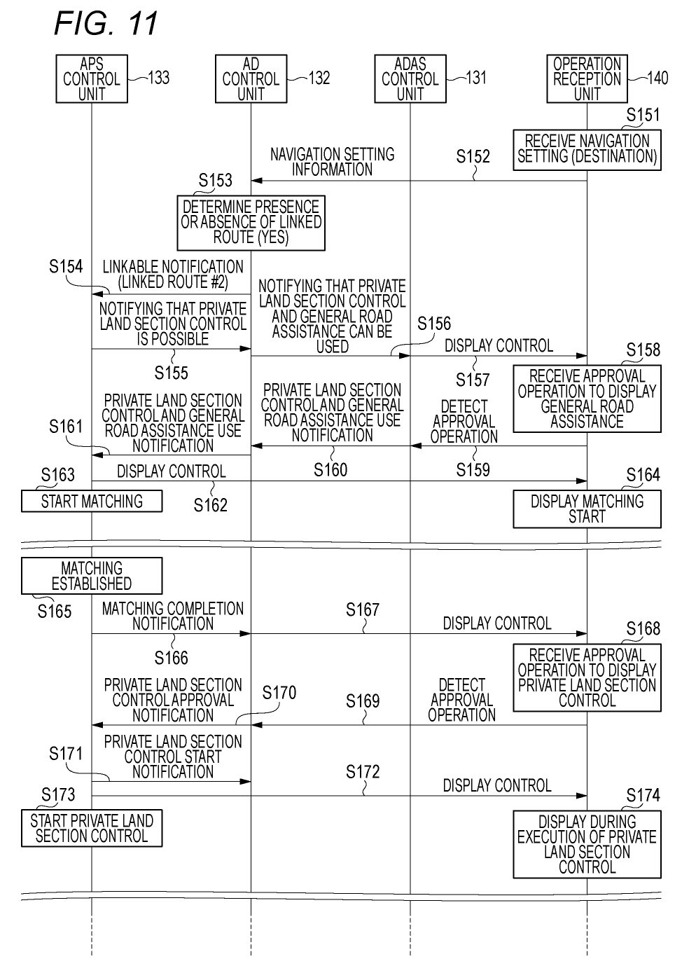

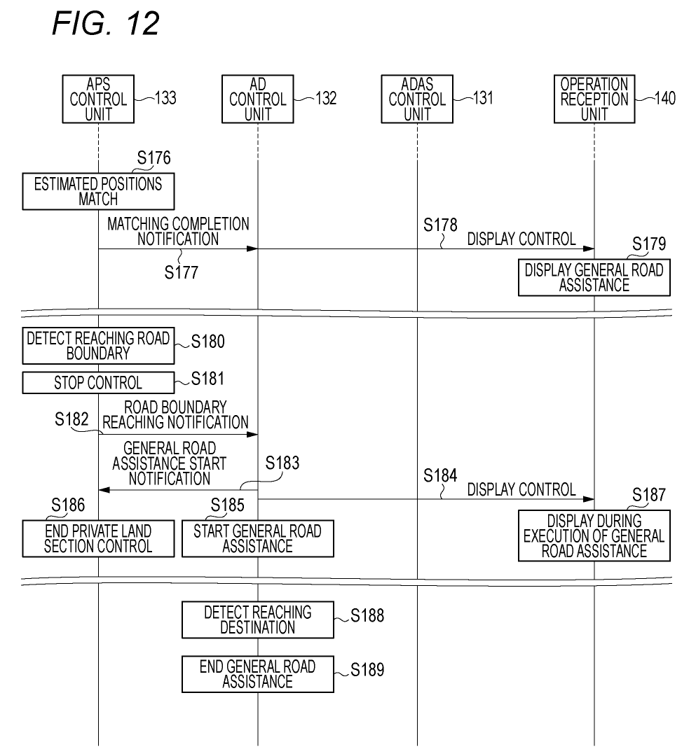

FIGS. 11 and 12 are sequence diagrams showing a fourth operation example of the vehicle 1. The fourth operation example is the same as the third operation example as being an operation example in a case where the user who gets on the vehicle 1 causes the vehicle 1 to exit the parking lot at home and goes out, but is different from the third operation example in that the route information when the vehicle 1 is caused to exit the parking lot at home is stored in the storage unit 120 and the vehicle 1 can exit the parking lot at home under the private land section control.

In FIG. 11, processing of step S151 and step S152 is similar to processing of step S111 and step S112 in the third operation example in FIG. 8.

In the travel control of the vehicle 1 from the parking lot at home to the destination, the AD control unit 132 determines whether the route linked to the travel route of the general road assistance is stored in the storage unit 120, that is, determines the presence or absence of the linked route along which the vehicle 1 travels on the private land between the parking lot at home and the general road (step S153). As described above, the linked route #2 when the vehicle 1 exits the parking lot at home is stored in the storage unit 120 in association with the route information on the exiting operation stored by the private land section memorizing and the road boundary information. Therefore, the determination for the presence or absence of the linked route is "YES". The AD control unit 132 notifies the APS control unit 133 that there is a linked route, that is, the link to the private land section control is likely to be possible (step S154). The stored linked route is, for example, the "linked route #2" stored in step S138 of the third operation example.

The APS control unit 133 notifies the AD control unit 132 that the vehicle 1 can be travel-controlled by the private land section control (step S155).

The AD control unit 132 notifies the ADAS control unit 131 that the travel control based on the private land section control and the travel control based on the general road assistance after the private land section control can be used (step S156).

The ADAS control unit 131 performs display control on the operation reception unit 140 to display on the navigation HMI 62 that the travel control based on the general road assistance can be used in the travel control of the vehicle 1 to the current destination (step S157).

The operation reception unit 140 displays on the navigation HMI 62 that the travel control based on the general road assistance can be used (step S158). It is assumed that the user approves the use of the general road assistance in response to the display. The operation reception unit 140 receives an approval operation from the user on the navigation HMI 62 (step S158). The operation reception unit 140 outputs, to the ADAS control unit 131, an operation detection signal notifying that the approval operation from the user is detected (step S159).

When receiving the operation detection signal from the operation reception unit 140, the ADAS control unit 131 notifies the AD control unit 132 that the travel control based on the private land section control and the travel control based on the general road assistance after the private land section control are to be used (step S160).

The AD control unit 132 notifies the APS control unit 133 that the travel control based on the private land section control and the travel control based on the general road assistance after the private land section control are to be used (step S161).

When receiving a private land section control and general road assistance use notification from the AD control unit 132, the APS control unit 133 performs display control on the operation reception unit 140 to display, on the navigation HMI 62, a screen for notifying the user of the start of matching (step S162). Then, the APS control unit 133 starts preparation of the matching for the private land section control (step S163).

The operation reception unit 140 displays, on the navigation HMI 62, a matching start, which is a screen display for notifying that the matching for the private land section control is started (step S164). For example, the operation reception unit 140 displays "The matching for the private land section control is started." on the navigation HMI 62. A purpose of the private land section control is to perform control to cause the vehicle 1 to exit the parking lot 170 at home.

Then, when the matching is established (step S165), the APS control unit 133 notifies the AD control unit 132 that the matching is completed (step S166). The matching being established means that a degree of matching between the current external environment information obtained by the external environment recognition unit 110 and, for example, the route information on the exiting operation associated with the linked route #2 is equal to or greater than a threshold.

The AD control unit 132 performs display control on the operation reception unit 140 to display on the navigation HMI 62 that the matching is completed and the private land section control is possible in exiting control of the vehicle 1 from the parking lot because the matching is completed (step S167). By performing the display control on the operation reception unit 140, the AD control unit 132 prompts the user to perform an approval operation of the control transition to transition the travel control of the vehicle 1 from the general road assistance to the private land section control.

In order to notify the user, the operation reception unit 140 displays on the navigation HMI 62 that the matching is completed and the private land section control is possible (step S168). It is assumed that the user approves the use of the private land section control in response to the notification. The operation reception unit 140 receives an approval operation from the user on the navigation HMI 62 (step S168). The operation reception unit 140 outputs, to the AD control unit 132, an operation detection signal notifying that the approval operation from the user is detected (step S169).

The AD control unit 132 notifies the APS control unit 133 that the user approves the use of the private land section control, based on the operation detection signal from the operation reception unit 140 (step S170).

The APS control unit 133 notifies the AD control unit 132 that the travel control of the vehicle 1 based on the private land section control is to be started (step S171). The APS control unit 133 performs display control on the operation reception unit 140 to display on the navigation HMI 62 that the vehicle 1 is to travel under the private land section control (step S172). Then, the APS control unit 133 starts the private land section control of the vehicle 1 (step S173).

The operation reception unit 140 displays, on the navigation HMI 62, a screen during execution of the private land section control for notifying that the vehicle 1 is traveling under the private land section control (step S174).

Next, the APS control unit 133 performs the matching processing between the position of the vehicle 1 estimated under the general road assistance and the position of the vehicle 1 estimated under the private land section control. Then, when the estimated positions match each other (step S176), the APS control unit 133 notifies the AD control unit 132 that the matching is completed (step S177). The matching determination of the estimated positions is similar to the matching determination described in FIGS. 5 and 6.

The AD control unit 132 performs display control on the operation reception unit 140 to display on the navigation HMI 62 that the matching is completed and the general road assistance is possible in the exiting control of the vehicle 1 from the parking lot because the matching is completed (step S178). At this time, the AD control unit 132 proceeds to next processing without receiving, from the user, an approval operation for transitioning the travel control of the vehicle 1 from the private land section control to the general road assistance. In order to notify the user, the operation reception unit 140 displays on the navigation HMI 62 that the matching is completed and the general road assistance is possible (step S179).

Next, the APS control unit 133 detects that the vehicle 1 reaches a road boundary under the travel control based on the private land section control (step S180). The road boundary is, for example, the position of the road boundary set by the user in the third operation example described above. The APS control unit 133 performs control to temporarily stop the vehicle 1 at the road boundary (step S181). The APS control unit 133 notifies the AD control unit 132 that the vehicle 1 reaches the road boundary (step S182).

When receiving a road boundary reaching notification from the APS control unit 133, the AD control unit 132 notifies the APS control unit 133 that the travel control based on the general road assistance is started for the vehicle 1 (step S183). The AD control unit 132 performs display control on the operation reception unit 140 to display on the navigation HMI 62 that the general road assistance for the vehicle 1 is to be started (step S184). Then, the AD control unit 132 starts the general road assistance (step S185).

Since the estimated positions match each other in step S176 described above, the transition to the general road assistance is performed without receiving the approval operation from the user, but when the estimated positions do not match each other in step S176, the movement control unit 130 may not transition to the general road assistance or may transition to the general road assistance after receiving the approval operation from the user.

The APS control unit 133 receives a general road assistance start notification from the AD control unit 132 and ends the private land section control (step S186).

The operation reception unit 140 displays, on the navigation HMI 62, a screen during execution of the general road assistance for notifying that the vehicle 1 is traveling under the general road assistance (step S187).

When the vehicle 1 travels to the destination under the general road assistance, the AD control unit 132 detects that the vehicle 1 reaches the destination (step S188). When the vehicle 1 reaches the destination, the AD control unit 132 ends the general road assistance (step S189).

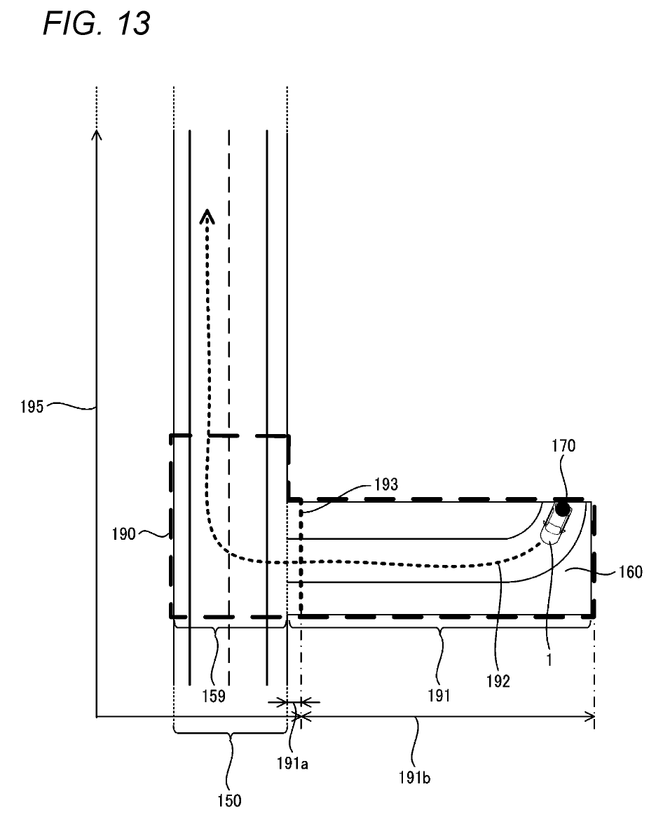

FIG. 13 is a diagram showing a next example of the state in which the vehicle 1 on which the user gets travels with the parking lot 170 at home as the operation start position. The next example is a travel example in a situation in which the route information when the vehicle 1 exits the parking lot 170 at home is stored, as described in the fourth operation example of FIGS. 11 and 12. FIG. 13 shows a situation in which a destination is set in the navigation device 60 to allow the vehicle 1 to head toward the destination.

In the travel control from the parking lot 170 at home to the destination, the vehicle 1 determines whether the linked route for traveling on the private land 160 between the parking lot 170 and the general road 150 is stored in the storage unit 120. As described in the above third operation example, it is assumed that the linked route #2 is stored in the storage unit 120.

The vehicle 1 starts determination as to whether the matching is established between the current external environment information obtained by the external environment recognition unit 110 and the route information on the exiting operation associated with the linked route #2. When the matching is established, the vehicle 1 obtains an approval of the user for execution of the private land section control, and starts the private land section control based on the route information on the exiting operation associated with the linked route #2.

The vehicle 1 starts matching processing between the position of the vehicle 1 estimated under the general road assistance and the position of the vehicle 1 estimated under the private land section control, together with the start of the private land section control. Here, it is assumed that the estimated positions match with each other at a time point when the vehicle 1 reaches the road boundary 193 at the latest.

In FIG. 13, as the movement route 192 in the private land section memorizing section 190 surrounded by a thick broken line, the movement route 192 in the private land section memorizing section 190 stored in the storage unit 120 in the initial example (see FIG. 10) is applied. The private land section memorizing section 190 includes the driveway (private road) 191 on the private land 160 and the general road region 159 of the general road 150. In the private land section memorizing section 190, the road boundary 193 indicating a boundary of a region in which the vehicle 1 can travel under the private land section control is set. In the private land section memorizing section 190, a region to which the private land section control of the vehicle 1 is applied is a set private road region 191b in a section from the parking lot 170 to the road boundary 193. In an excluded private road region 191a on a general road region 159 side relative to the road boundary 193, the private land section control is not applied even if the excluded private road region 191a is within a region of the driveway 191.

The vehicle 1 is travel-controlled by the private land section control in the set private road region 191b from the parking lot 170 to the road boundary 193, and is travel-controlled by the general road assistance when traveling to the excluded private road region 191a beyond the road boundary 193 because the matching for the positions of the vehicle 1 estimated under self-position estimation is established in this example. The set private road region 191b is a travel-possible area in which the vehicle 1 can travel under the private land section control. The travel-possible area is an area set by the user setting the road boundary 193. The section in which the general road assistance is performed is the general road assistance section 195.

From the above, according to the control device 100, in a case where the vehicle 1 is controlled to exit the parking lot at home and travel to the destination as in the third operation example and the fourth operation example, it is also possible to achieve similar effects as in a case where the vehicle 1 is controlled to travel from the destination to enter the parking lot at home in the first operation example and the second operation example described above.

### Example of Use of Private Land Section Control

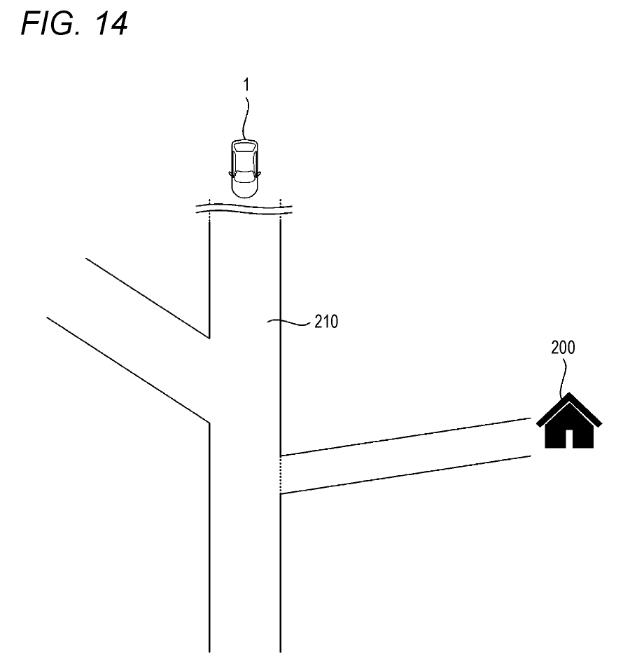

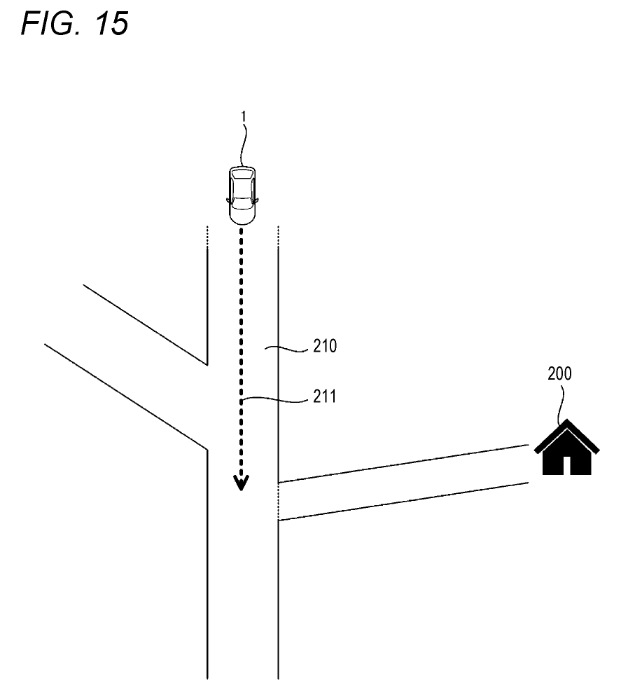

The private land section control used when the user the vehicle 1 returns home from the destination will be described with reference to FIGS. 14 to 19. FIG. 14 is a diagram showing a state in which the user gets on the vehicle 1 and starts the engine at the destination. The user first sets a home 200 as a target position in the navigation device 60. FIG. 15 is a diagram showing a state in which the vehicle 1 is traveling on a general road 210 under the general road assistance. The vehicle 1 is traveling on the general road 210 along a route indicated by an arrow 211, for example, under the travel control based on the general road assistance.

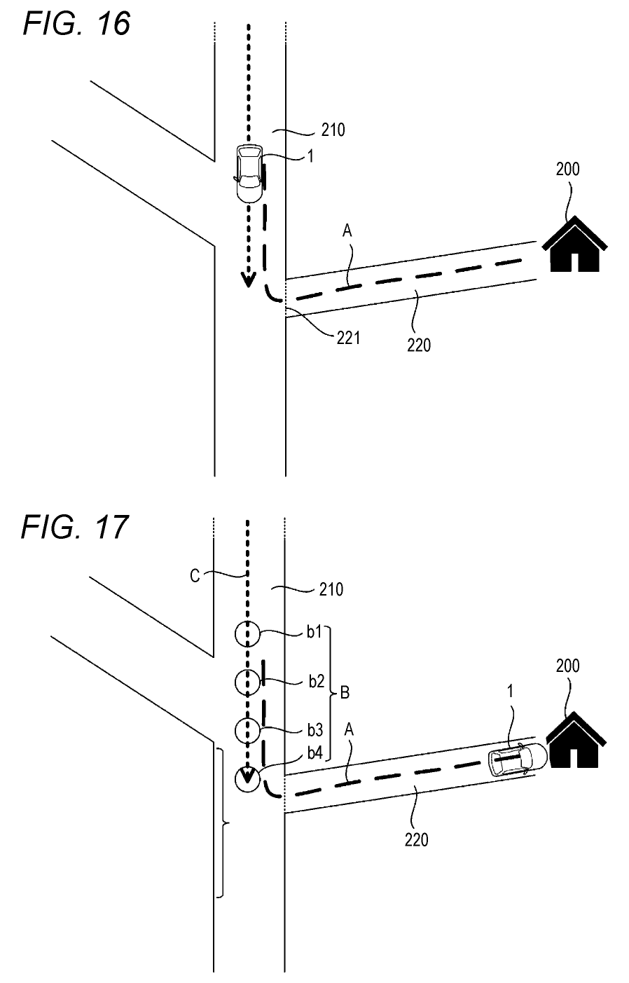

FIG. 16 is a diagram showing a start of the private land section memorizing of the vehicle 1. In a case where no linked route taken during past travel is stored in the storage unit 120, when a travel position of the vehicle 1 reaches, for example, a determination area in which a remaining distance to the home 200 is 88 m or less and an override operation of the user is started, the vehicle 1 stores route information on the override operation by the private land section memorizing.

For example, in FIG. 16, information on a movement route A of the vehicle 1 indicated by a broken line is stored by the private land section memorizing. The information on the movement route A includes information on a travel route of the override operation on the general road 210 and information on a travel route of the override operation on a driveway 220 extending to the home 200 continuously from the general road 210. The information on the movement route A includes information on a road boundary 221 indicating a boundary of the driveway 220. A region of the driveway 220 is a region of the movement route A on a home 200 side relative to the road boundary 221. The information on the movement route A includes information on a travel route on which the vehicle turns left on the general road 210 and enters the driveway 220.

FIG. 17 is a diagram showing a state in which the vehicle 1 reaches the home 200 which is the target position. When the vehicle 1 reaches the home 200, in addition to the information on the movement route A stored by the private land section memorizing in FIG. 16, information on a linked route in a travel route from the destination to the home 200 is further stored by the private land section memorizing.

For example, information on a linked route B indicated by circles b1 to b4 in FIG. 17 is stored by the private land section memorizing. The linked route B is stored by the private land section memorizing as route information linked to a travel route C of the general road assistance on the general road 210. Accordingly, when the travel control of the vehicle 1 transitions from the general road assistance to the private land section control in the travel route from the destination to the home 200, information indicating that the vehicle 1 transitions to the movement route A while traveling on the general road 210 toward the circle b1 → b2 → b3 → b4 as on the linked route B is stored by the private land section memorizing.

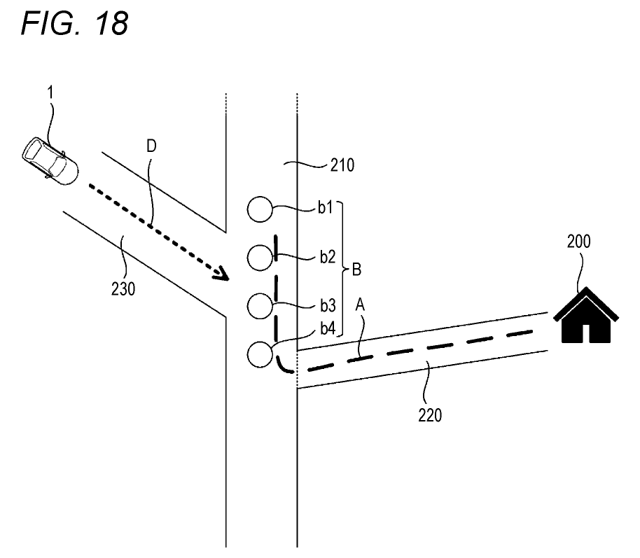

FIG. 18 is a diagram showing a state of the vehicle 1 returning to the home 200 along a travel route D different from the travel route C in FIG. 17. In FIG. 18, the travel control of the vehicle 1 under the general road assistance is performed on the travel route D indicated by a broken line of a general road 211. The travel route D is a route different from the travel route C (see FIG. 17) of the general road 210 to which the linked route B is linked. Therefore, the linked route B linked to the travel route C of the general road assistance on the general road 210 is not applied to the vehicle 1 that travels on the travel route D of the general road 211 under the general road assistance. It is determined that there is no linked route on the travel route D on which the general road assistance is performed on the vehicle 1 on the general road 211.

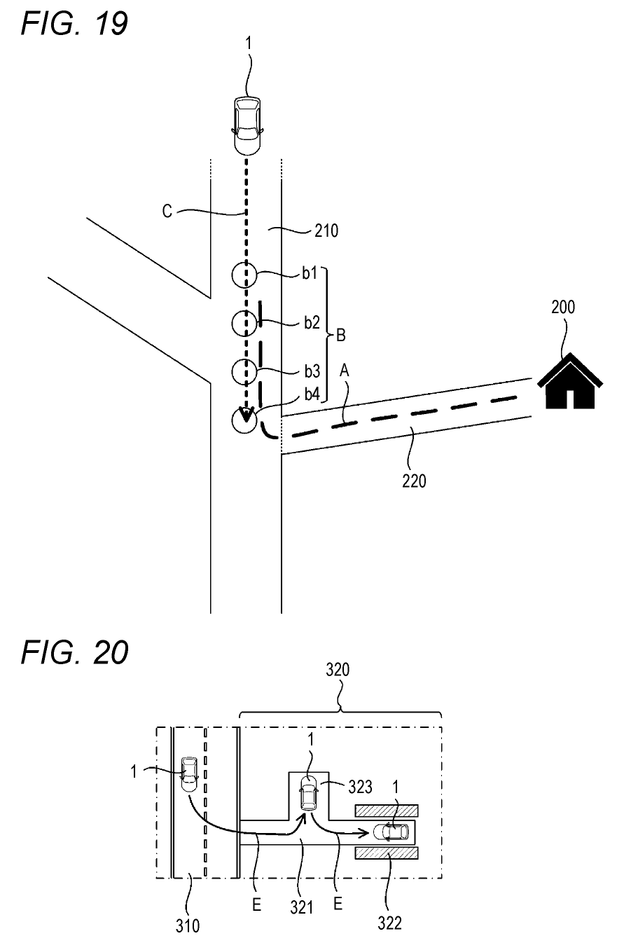

FIG. 19 is a diagram showing a state of the vehicle 1 returning to the home 200 along the same travel route as the travel route C in FIG. 17. In FIG. 19, the travel control of the vehicle 1 under the general road assistance is performed on the travel route C indicated by a broken line of the general road 210. The travel route C is the same route as the travel route C of the general road 210 to which the linked route B stored by the private land section memorizing in FIG. 17 is linked.

Therefore, the vehicle 1 reads the information on the movement route A stored in association with the linked route B by the private land section memorizing and performs matching for the private land section control. When the matching for the private land section control is established, the vehicle 1 performs matching processing between the position of the vehicle 1 estimated under the general road assistance and the position of the vehicle 1 estimated under the private land section control. Then, when the matching for the private land section control is established and the estimated positions match each other, the vehicle 1 transitions from the general road assistance to the private land section control, and causes the vehicle 1 to travel to the home 200 based on the information on the movement route A and the current external environment information.

In FIGS. 14 to 19 described above, a case where the vehicle 1 travels from the destination to home has been described, but the present invention is not limited thereto. For example, the travel control can also transition similarly in a case of traveling from home to the destination.

### Switching of Travel Mode at Travel Direction Switching Position

FIG. 20 is a diagram showing an example of switching of the travel mode at a travel direction switching position. Here, a case of transition from a general road 310 to a private road 321, that is, a case where the first travel mode is the general road assistance and the second travel mode is the private land section control will be described. In FIG. 20, a private land 320 includes the private road 321 and a garage 322, and the private road 321 includes a branch road 323 on which a direction of the vehicle 1 can be switched by turning. The garage 322 is an example of a storage facility of the vehicle 1.

A movement route E is a movement route of the vehicle 1 stored by the private land section memorizing. Specifically, the movement route E is a movement route for switching the direction by entering the private road 321 of the private land 320 from the general road 310, turning left while moving forward to enter the branch road 323, and turning right while moving backward to exit the branch road 323, and for parking into the garage 322 while moving backward.

When such a movement route E is stored by the private land section memorizing and a specific condition is satisfied, instead of the control of the second operation example described above, the movement control unit 130 may perform matching for the private land section control at a time point when the vehicle 1 reaches the branch road 323, and transition the travel mode of the vehicle 1 from the general road assistance (first travel mode) to the private land section control (second travel mode) when the matching is established. Accordingly, the above matching for the private land section control is performed in a state where the vehicle 1 is temporarily stopped or in a state where the vehicle 1 is at a low speed before and after the temporary stop, and the matching can be accurately performed. In this case, the travel mode of the vehicle 1 can also be transitioned without receiving an approval operation related to the transition of the travel mode from the user.

In this case, regarding a route from the vehicle 1 entering the private road 321 to entering the branch road 323, the movement control unit 130 may cause the vehicle 1 to travel by the general road assistance if the travel based on the general road assistance is possible, and may prompt the user (driver) to drive until the vehicle 1 enters the branch road 323 if the travel based on the general road assistance is not possible.

The "specific condition" is, for example, that a distance (private road distance) from entering the private road 321 to reaching the garage 322 (target position) is less than a predetermined value. For example, the movement control unit 130 determines whether the private road distance is equal to or greater than the predetermined value when the branch road 323 (position where the travel direction is switched) is present. The private road distance may be determined based on the external environment information obtained by the external environment recognition unit 110, or may be determined based on the map information or the like that can be referred to by the vehicle 1.

When the private road distance is equal to or greater than the predetermined value, the movement control unit 130 transitions the travel mode of the vehicle 1 from the general road assistance to the private land section control by performing the matching at a time point when the vehicle 1 enters the determination area, as in the second operation example. Further, when the private road distance is less than the predetermined value, as described in FIG. 20, the movement control unit 130 transitions the travel mode of the vehicle 1 from the general road assistance to the private land section control by performing the matching for the private land section control at the time point when the vehicle 1 reaches the branch road 323.

In this way, a trigger for the transition of the travel mode varies depending on a length of an approach from the general road 310 to the garage 322 (target position).

### Switching of Travel Mode at Travel Direction Switching Position

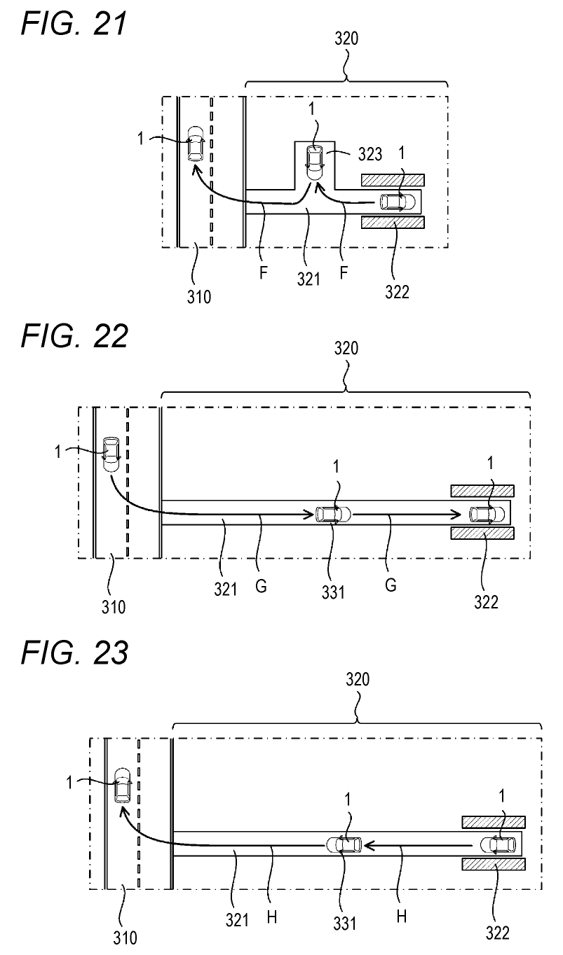

FIG. 21 is a diagram showing another example of switching of the travel mode at the travel direction switching position. In FIG. 21, portions similar to those shown in FIG. 20 are denoted by the same reference numerals, and the description thereof will be omitted. Here, a case of transition from the private road 321 to the general road 310, that is, a case where the first travel mode is the private land section control and the second travel mode is the general road assistance will be described.

A movement route F is a movement route of the vehicle 1 stored by the private land section memorizing. Specifically, the movement route F is a movement route for switching the direction by exiting the garage 322 by backward movement, turning left while moving backward to enter the branch road 323, and turning right while moving forward to leave from the branch road 323, and for exiting onto the general road 310 while moving forward.

When such a movement route F is stored by the private land section memorizing and a specific condition is satisfied, instead of the control of the fourth operation example described above, the movement control unit 130 may transition the travel mode of the vehicle 1 from the private land section control (first travel mode) to the general road assistance (second travel mode) at a time point when the vehicle 1 reaches the branch road 323. In this case, the travel mode of the vehicle 1 can also be transitioned without receiving an approval operation related to the transition of the travel mode from the user.

In this case, regarding a route from the vehicle 1 entering the branch road 323 to exiting onto the general road 310, the movement control unit 130 may cause the vehicle 1 to travel by the general road assistance if the travel based on the general road assistance is possible, and may prompt the user (driver) to drive until the vehicle 1 exits onto the general road 310 if the travel based on the general road assistance is not possible.

For example, the movement control unit 130 determines whether the private road distance is equal to or greater than the predetermined value when the branch road 323 (position where the travel direction is switched) is present. Then, when the private road distance is equal to or greater than the predetermined value, the movement control unit 130 transitions the travel mode of the vehicle 1 from the private land section control to the general road assistance by performing the matching together with the start of the private land section control, as in the fourth operation example described above. When the private road distance is less than the predetermined value, the movement control unit 130 transitions the travel mode of the vehicle 1 from the private land section control to the general road assistance at the time point when the vehicle 1 reaches the branch road 323, as described with reference to FIG. 21.

In this way, a trigger for the transition of the travel mode varies depending on a length of an approach from the garage 322 to the general road 310.

### Switching of Travel Mode at Temporary Stop Position

FIG. 22 is a diagram showing an example of switching of the travel mode at a temporary stop position. In FIG. 22, portions similar to those shown in FIGS. 20 and 21 are denoted by the same reference numerals, and the description thereof will be omitted. Here, a case of transition from a general road 310 to a private road 321, that is, a case where the first travel mode is the general road assistance and the second travel mode is the private land section control will be described.

In the example of FIG. 22, a temporary stop position 331 is set on the private road 321. For example, when the garage 322 is detected during travel on the private road 321 toward the target position (garage 322) under the private land section control, the movement control unit 130 sets a position a certain distance before the garage 322 as the temporary stop position 331 in the first operation example. The garage 322 is detected based on, for example, the external environment information obtained by the external environment recognition unit 110.

A movement route G is a movement route of the vehicle 1 stored by the private land section memorizing. Specifically, the movement route G is a movement route for entering the private road 321 of the private land 320 from the general road 310 and parking into the garage 322. Here, since the temporary stop position 331 is set on the private road 321, the movement control unit 130 temporarily stops the vehicle 1 at the temporary stop position 331 when controlling the travel of the vehicle 1 along the movement route G by the private land section control. Accordingly, map information with high accuracy at the temporary stop position 331 can be generated.

When such a movement route G is stored by the private land section memorizing, instead of the control of the second operation example described above, the movement control unit 130 may perform matching for the private land section control at a time point when the vehicle 1 reaches the temporary stop position 331, and transition the travel mode of the vehicle 1 from the general road assistance (first travel mode) to the private land section control (second travel mode) when the matching is established. Accordingly, the above matching for the private land section control is performed in a state where the vehicle 1 is temporarily stopped, and the matching can be accurately performed. In this case, the travel mode of the vehicle 1 can also be transitioned without receiving an approval operation related to the transition of the travel mode from the user.

In this case, regarding a route from the vehicle 1 entering the private road 321 to reaching the temporary stop position 331, the movement control unit 130 may cause the vehicle 1 to travel by the general road assistance if the travel based on the general road assistance is possible, and may prompt the user (driver) to drive until the vehicle 1 reaches the temporary stop position 331 if the travel based on the general road assistance is not possible.

In this way, when a position of the garage 322 (storage facility) of the vehicle 1 is detected, a position at a certain distance before the garage 322 may be set as a position where the vehicle 1 is temporarily stopped and the travel mode is transitioned.

FIG. 23 is a diagram showing an example of switching of the travel mode at the temporary stop position. In FIG. 23, the portions similar to those illustrated in FIG. 22 are denoted by the same reference numerals, and the description thereof will be omitted. Here, a case of transition from the private road 321 to the general road 310, that is, a case where the first travel mode is the private land section control and the second travel mode is the general road assistance will be described. In the example of FIG. 23, the temporary stop position 331 is also set on the private road 321.

A movement route H is a movement route of the vehicle 1 stored by the private land section memorizing. Specifically, the movement route H is a movement route for exiting from the garage 322, passing through the private road 321, and exiting onto the general road 310.

When such a movement route H is stored by the private land section memorizing, instead of the control of the fourth operation example described above, the movement control unit 130 may transition the travel mode of the vehicle 1 from the private land section control (first travel mode) to the general road assistance (second travel mode) at a time point when the vehicle 1 reaches temporary stop position 331. In this case, the travel mode of the vehicle 1 can also be transitioned without receiving an approval operation related to the transition of the travel mode from the user.

In this case, regarding a route from the vehicle 1 reaching the temporary stop position 331 to exiting onto the general road 310, the movement control unit 130 may cause the vehicle 1 to travel by the general road assistance if the travel based on the general road assistance is possible, and may prompt the user (driver) to drive until the vehicle 1 exits onto the general road 310 if the travel based on the general road assistance is not possible.

The vehicle control method described in the above embodiment may be implemented by a computer executing a vehicle control program prepared in advance. The vehicle control program is stored in a computer-readable storage medium and executed by being read from the storage medium. Further, the vehicle control program may be provided in a form of being stored in a non-transitory storage medium such as a flash memory, or may be provided via a network such as the Internet. The computer that executes the vehicle control program may be provided in the control device, may be provided in an electronic device such as a smartphone, a tablet terminal, or a personal computer that can communicate with the control device, or may be provided in a server device that can communicate with the control device and the electronic device.

Although the embodiment of the present disclosure has been described above, the present invention is not limited to the above-described embodiment, and modifications, improvements, and the like can be appropriately made.

For example, although an example in which the moving object is a vehicle has been described in the above embodiment, the present invention is not limited thereto. The idea of the present invention is not limited to the vehicle, and may also be applied to a robot, a ship, an aircraft, or the like that includes a drive source and that can be moved by power of the drive source.

In the present specification, at least the following matters are described. In the parentheses, the corresponding constituent elements and the like in the above embodiment are shown, but the present invention is not limited thereto.

(1) A vehicle control device (control device 100) capable of transitioning travel control between a first travel mode and a second travel mode, the vehicle control device including:

at least one processor (movement control unit 130, ADAS control unit 131, AD control unit 132, APS control unit 133) configured to perform travel control for moving a vehicle to a target position, in which

the processor is configured to

when the vehicle enters a predetermined determination area while the vehicle is traveling in the first travel mode, determine whether a travel condition of the second travel mode is satisfied by matching processing between a position of the vehicle estimated in the first travel mode and a position of the vehicle estimated in the second travel mode, and

transition to the second travel mode when the travel condition of the second travel mode is satisfied.

According to (1), in the determination of the travel condition in the second travel mode while the vehicle is traveling in the first travel mode, when the vehicle enters the predetermined determination area, the matching processing between the position of the vehicle estimated in the first travel mode and the position of the vehicle estimated in the second travel mode is performed, thus the switching from the first travel mode to the second travel mode can be performed more safely and reliably, and the transition to the second travel mode can be performed without receiving an approval operation for transitioning to the second travel mode from a user. Therefore, the user can transition the travel mode to the second travel mode without performing the approval operation for the transition to the second travel mode, and does not need to perform a complicated operation. Accordingly, it is possible to smoothly perform the transition in control between the travel control in the first travel mode and the travel control in the second travel mode in the vehicle.

(2) The vehicle control device according to (1), in which

when the vehicle enters the predetermined determination area while the vehicle is traveling in the first travel mode, the processor

performs deceleration control of the vehicle to determine whether the travel condition of the second travel mode is satisfied and

issues a first notification regarding the deceleration control to the user.

According to (2), when the vehicle enters the determination area in the first travel mode, in order to determine the travel condition for transitioning to the second travel mode, the vehicle is decelerated, the user is notified of the deceleration, and thereby the mode transition can be further smoothed.

(3) The vehicle control device according to (1) or (2), in which

when the vehicle enters the determination area while the vehicle is traveling in the first travel mode, the processor issues a second notification prompting the user to perform deceleration control of the vehicle to determine whether the travel condition of the second travel mode is satisfied.

According to (3), when the vehicle enters the determination area in the first travel mode, the mode transition can also be smoothed when the user performs the deceleration control of the vehicle in order to determine the travel condition for transitioning to the second travel mode.

(4) The vehicle control device according to any of (1) to (3), in which

the travel condition of the second travel mode includes a condition that a route to the target position includes a region in which the vehicle is able to travel in the second travel mode.

According to (4), as the travel condition for the transition from the first travel mode to the second travel mode, it is necessary that the region in which the vehicle can travel in the second travel mode is included in the route to the target position.

(5) The vehicle control device according to any of (1) to (4), further including

a memory (storage unit 120) to store map information, in which

the processor (external environment recognition unit 110) is configured to perform external environment recognition, and

the processor controls the vehicle to travel in the second travel mode based on the map information stored in the memory and external environment information obtained by the processor.

As in (5), when being caused to travel in the second travel mode, the vehicle travels based on the stored map information and the obtained current external environment information, and thus can travel on an appropriate route.

(6) The vehicle control device according to (5), in which

the travel condition of the second travel mode includes a condition that the external environment information obtained by the processor in the predetermined determination area and the map information stored in the memory satisfy a predetermined matching condition.

As in (6), when being caused to travel in the second travel mode, the vehicle travels based on the stored map information and the obtained current external environment information, and thus can travel on an appropriate route.

(7) The vehicle control device according to (5) or (6), in which

in the memory, a past travel route taken by the vehicle and the map information based on the external environment information obtained by the processor during a travel on the past travel route are stored in association with each other, and

the processor controls the vehicle to travel in the second travel mode based on the map information stored in the memory that is associated with a travel route of the vehicle and the external environment information obtained by the processor.

According to (7), when being caused to travel in the second travel mode, the vehicle travels based on the map information corresponding to a current travel route of the vehicle among the stored map information and the obtained current external environment information, and thus the mode transition from the first travel mode to the second travel mode can be smoothed.

(8) The vehicle control device according to any of (1) to (7), in which

the first travel mode is a travel mode to be applied to travel of the vehicle on a general road and a highway, and

the second travel mode is a travel mode to be applied to travel of the vehicle on a private land.

As in (8), it is possible to apply the present embodiment to a case of transition from travel on the general road and the highway to travel on the private land.

(9) The vehicle control device according to any of (1) to (7), in which

the first travel mode is a travel mode to be applied to travel of the vehicle on a private land, and

the second travel mode is a travel mode to be applied to travel of the vehicle on a general road and a highway.

As in (9), it is possible to apply the present embodiment to a case of transition from travel on the private land to travel on the general road and the highway.

(10) The vehicle control device according to (8) or (9), in which

the processor transitions from the first travel mode to the second travel mode at a position at which a travel direction of the vehicle is switched, when a specific condition is satisfied in the travel of the vehicle on the private land.

According to (10), since the transition from the first travel mode to the second travel mode can be performed at the position where the travel direction of the vehicle is switched, the transition of the travel mode can be reliably performed.

(11) The vehicle control device according to (8) or (9), in which

when a position of a storage facility of the vehicle is detected, the processor sets a position at a certain distance before the storage facility as a position at which the vehicle is temporarily stopped and transitions from the first travel mode to the second travel mode.

According to (11), the vehicle can be temporarily stopped at the position at a certain distance before the storage facility, and the transition of the travel mode can be reliably performed.

(12) The vehicle control device according to any of (1) to (11), in which

the first travel mode and the second travel mode are travel modes using map information of different formats.

According to (12), the transition from the first travel mode to the second travel mode, which use the map information of different formats, can be smoothly performed.

(13) A non-transitory computer-readable storage medium storing a vehicle control program for a vehicle control device causing the processor to perform processing, the vehicle control device including at least one processor that performs travel control for moving a vehicle to a target position and capable of transitioning travel control between a first travel mode and a second travel mode,

the processing including:

when the vehicle enters a predetermined determination area while the vehicle is traveling in the first travel mode, determining whether a travel condition of the second travel mode is satisfied by matching processing between a position of the vehicle estimated in the first travel mode and a position of the vehicle estimated in the second travel mode; and

transitioning to the second travel mode when the travel condition of the second travel mode is satisfied.

According to (13), in the determination of the travel condition in the second travel mode while the vehicle is traveling in the first travel mode, when the vehicle enters the predetermined determination area, the matching processing between the position of the vehicle estimated in the first travel mode and the position of the vehicle estimated in the second travel mode is performed, thus the switching from the first travel mode to the second travel mode can be performed more safely and reliably, and the transition to the second travel mode can be performed without receiving an approval operation for transitioning to the second travel mode from the user. Therefore, the user can transition the travel mode to the second travel mode without performing the approval operation for the transition to the second travel mode, and does not need to perform a complicated operation. Accordingly, it is possible to smoothly perform the transition in control between the travel control in the first travel mode and the travel control in the second travel mode in the vehicle.

What is claimed is:

1. A vehicle control device capable of transitioning travel control between a first travel mode and a second travel mode, the vehicle control device comprising:
at least one processor configured to perform travel control for moving a vehicle to a target position, wherein
the processor is configured to
when the vehicle enters a predetermined determination area while the vehicle is traveling in the first travel mode, determine whether a travel condition of the second travel mode is satisfied by matching processing between a position of the vehicle estimated in the first travel mode and a position of the vehicle estimated in the second travel mode, and
transition to the second travel mode when the travel condition of the second travel mode is satisfied.

2. The vehicle control device according to claim 1, wherein
when the vehicle enters the predetermined determination area while the vehicle is traveling in the first travel mode, the processor
performs deceleration control of the vehicle to determine whether the travel condition of the second travel mode is satisfied and
issues a first notification regarding the deceleration control to the user.

3. The vehicle control device according to claim 1, wherein
when the vehicle enters the determination area while the vehicle is traveling in the first travel mode, the processor issues a second notification prompting the user to perform deceleration control of the vehicle to determine whether the travel condition of the second travel mode is satisfied.

4. The vehicle control device according to claim 1, wherein
the travel condition of the second travel mode includes a condition that a route to the target position includes a region in which the vehicle is able to travel in the second travel mode.

5. The vehicle control device according to claim 1, further comprising
a memory to store map information, wherein
the processor is configured to perform external environment recognition, and
the processor controls the vehicle to travel in the second travel mode based on the map information stored in the memory and external environment information obtained by the processor.

6. The vehicle control device according to claim 5, wherein
the travel condition of the second travel mode includes a condition that the external environment information obtained by the processor in the predetermined determination area and the map information stored in the memory satisfy a predetermined matching condition.

7. The vehicle control device according to claim 5, wherein
in the memory, a past travel route taken by the vehicle and the map information based on the external environment information obtained by the processor during a travel on the past travel route are stored in association with each other, and
the processor controls the vehicle to travel in the second travel mode based on the map information stored in the memory that is associated with a travel route of the vehicle and the external environment information obtained by the processor.

8. The vehicle control device according to claim 1, wherein
the first travel mode is a travel mode to be applied to travel of the vehicle on a general road and a highway, and
the second travel mode is a travel mode to be applied to travel of the vehicle on a private land.

9. The vehicle control device according to claim 1, wherein
the first travel mode is a travel mode to be applied to travel of the vehicle on a private land, and
the second travel mode is a travel mode to be applied to travel of the vehicle on a general road and a highway.

10. The vehicle control device according to claim 8, wherein
the processor transitions from the first travel mode to the second travel mode at a position at which a travel direction of the vehicle is switched, when a specific condition is satisfied in the travel of the vehicle on the private land.

11. The vehicle control device according to claim 8, wherein
when a position of a storage facility of the vehicle is detected, the processor sets a position at a certain distance before the storage facility as a position at which the vehicle is temporarily stopped and transitions from the first travel mode to the second travel mode.

12. The vehicle control device according to claim 1, wherein
the first travel mode and the second travel mode are travel modes using map information of different formats.

13. A non-transitory computer-readable storage medium storing a vehicle control program for a vehicle control device causing the processor to perform processing, the vehicle control device including at least one processor that performs travel control for moving a vehicle to a target position and capable of transitioning travel control between a first travel mode and a second travel mode,
the processing comprising:
when the vehicle enters a predetermined determination area while the vehicle is traveling in the first travel mode, determining whether a travel condition of the second travel mode is satisfied by matching processing between a position of the vehicle estimated in the first travel mode and a position of the vehicle estimated in the second travel mode; and
transitioning to the second travel mode when the travel condition of the second travel mode is satisfied.
